(19) United States
(12) Patent Application Publication
(10) Pub. No.: US 2019/0040320 A1
(43) Pub. Date: Feb. 7, 2019

(54) ALIGNMENT FILM, POLYMER, AND LIQUID CRYSTAL DISPLAY DEVICE

(71) Applicant: SHARP KABUSHIKI KAISHA, Sakai City, Osaka (JP)

(72) Inventors: MASANOBU MIZUSAKI, Sakai City (JP); HIROSHI TSUCHIYA, Sakai City (JP)

(21) Appl. No.: 16/074,859

(22) PCT Filed: Feb. 1, 2017
(86) PCT No.: PCT/JP2017/003545

§ 371 Date: Aug. 2, 2018

(30) Foreign Application Priority Data
Feb. 3, 2016 (JP) 2016-019161

(51) Int. Cl. C09K 19/56; C08G 77/26; C08F 220/40; C08G 69/26; C08G 77/24; G02F 1/1337; G02F 1/137

(52) U.S. Cl. CPC C09K 19/56; C08G 77/26; C08F 220/40; G02F 2001/133397; C08G 77/24; G02F 1/133711; G02F 1/137; C08G 69/265

(57) ABSTRACT

The present invention provides a liquid crystal display device in which image sticking and stains are sufficiently reduced. The present invention relates to an alignment film including: a polymer containing a piperidine skeleton-containing group and/or a quinone group; and a photo-aligning functional group. The present invention also relates to a polymer for use in the alignment film, the polymer containing a piperidine skeleton-containing group and/or a quinone group. The present invention also relates to a liquid crystal display device including: the alignment film; a pair of substrates; and a liquid crystal layer disposed between the substrates, wherein the alignment film is disposed between at least one of the substrates and the liquid crystal layer.

### TECHNICAL FIELD

The present invention relates to alignment films, polymers, and liquid crystal display devices. The present invention in particular relates to alignment films containing photo-aligning functional groups (photo-alignment films), polymers for use in photo-alignment films, and liquid crystal display devices including at least one of these alignment films.

### BACKGROUND ART

Display devices such as liquid crystal display devices have rapidly spread in recent years and are used not only for televisions but also for a wide variety of devices such as electronic book readers, digital photo frames, industrial appliances, personal computers (PCs), tablet PCs, and smartphones. These devices are required to have various properties for the respective uses, and various liquid crystal display modes are developed.

Examples of the liquid crystal display modes include modes in which liquid crystal molecules are aligned in a direction substantially parallel to the main surfaces of the substrates when no voltage is applied (hereinafter, also referred to as horizontal alignment modes) such as the in-plane switching (IPS) mode and the fringe field switching (FFS) mode. Examples of the liquid crystal display modes also include modes in which liquid crystal molecules are aligned in a direction substantially perpendicular to the main surfaces of the substrates when no voltage is applied (hereinafter, also referred to as vertical alignment modes) such as the vertical alignment (VA) mode. In order to achieve such alignment control of liquid crystal molecules, use of an alignment film is proposed.

For example, to maintain good electric properties for a long time, Patent Literature 1 discloses the introduction, by an addition method, of an antioxidant into a liquid crystal alignment agent containing at least one polymer selected from the group consisting of a polyamic acid and a polyimide obtained by dehydration ring-opening thereof, and an epoxy group-containing compound, wherein the antioxidant has the chemical structure represented by the formula (1) of Patent Literature 1.

In alignment films containing photo-reactive functional groups, the photo-reactive functional groups undesirably thermally react when the film is heat-treated (fired) before alignment-treated by exposure to polarized light, thus decreasing the photo-alignment properties. Patent Literature 2, for example, discloses the introduction of a specific polymerization-inhibiting component by a technique of chemically bonding the component to a specific polysiloxane component, or a technique of adding the component to a specific polysiloxane component, so as to reduce the thermal reaction between photo-reactive functional groups.

### CITATION LIST

### Patent Literature

Patent Literature 1: JP 2012-194538 A
Patent Literature 2: WO 2014/073537

### SUMMARY OF INVENTION

### Technical Problem

### (Issues of a Polymer Containing a Photo-Aligning Functional Group as Alignment Film Material)

As mentioned above, especially liquid crystal displays including a photo-alignment film may suffer image sticking or stains after long exposure to light from the backlight or other external light, possibly causing a decrease in reliability.

The following will describe in detail the mechanism of the occurrence of image sticking and stains in a liquid crystal display including a photo-alignment film. When photo-aligning functional groups (e.g., a cinnamate group, a chalcone group, an azobenzene group, a coumarin group, a stilbene group, a tolane group) are decomposed by light irradiation to generate radicals, transfer of the generated radicals to liquid crystal molecules or dissolution of a polymer (e.g., a polysiloxane, a polyvinyl) with radicals generated therefrom into the liquid crystal layer increases the radical concentration in the liquid crystal layer. In addition, some radicals in the liquid crystal layer are ionized. The presence of such radicals and ions in the liquid crystal layer reduces the voltage holding ratio (VHR) of the liquid crystal display, causing image sticking and display stains.

FIG. 5 is a schematic view of conventional ion generation. Radicals are generated from a photo-aligning functional group contained in a low-molecular-weight compound in a photo-alignment film. The radicals dissolve into the liquid crystal layer and are transferred to liquid crystal molecules, and ions are generated from the radicals transferred to the liquid crystal molecules. In addition, the low-molecular-weight compound in the photo-alignment film dissolves into the liquid crystal layer. Radicals are generated from the photo-aligning functional group in the dissolved low-molecular-weight compound, and transferred to liquid crystal molecules. Ions are generated from the radicals transferred to the liquid crystal molecules.

The liquid crystal layer contains an antioxidant in order to prevent generation of image sticking and stains due to oxides. The antioxidant eliminates oxygen from oxides in the liquid crystal molecules and the alignment film generated due to the influence of light and heat in the presence of oxygen. Still, when radicals are generated from the photo-aligning functional groups in the photo-alignment film and directly react with the antioxidant, this antioxidant is consumed so that oxidation of liquid crystal molecules and the alignment film proceeds unfortunately. Oxides may also be converted into ions, which may cause a decrease in VHR. Such ions accumulate at ends of the display of a panel and edges of a window pattern display to decrease the VHR at these portions. As a result, the aforementioned image sticking and stain may occur. These defects seem to be visible when the luminance of the backlight is increased. In particular, such a phenomenon is more likely to occur with the use of a negative liquid crystal material containing a group that easily incorporates radicals such as an alkoxy group.

The present invention was made in view of the situation in the art and aims to provide a liquid crystal display device in which image sticking and stains are sufficiently reduced.

### Solution to Problem

The present inventors made various studies on liquid crystal display devices to arrive at the introduction of a functional group having a radical-scavenging function (radical-scavenging group) into a polymer constituting a photo-alignment film by a chemical bond.

The present inventors arrived at the solution of the above problems owing to the above configuration, completing the present invention.

One aspect of the present invention may be an alignment film including: a polymer containing a piperidine skeleton-containing group and/or a quinone group; and a photo-aligning functional group.

It is sufficient that the photo-aligning functional group is included in the alignment film, but preferably the photo-aligning functional group is introduced into a polymer by a chemical bond, more preferably introduced into the polymer containing a piperidine skeleton-containing group and/or a quinone group by a chemical bond.

Another aspect of the present invention may be a polymer for use in the alignment film of the present invention, the polymer containing: a piperidine skeleton-containing group and/or a quinone group.

Still another aspect of the present invention may be a liquid crystal display device including: the alignment film of the present invention; a pair of substrates; and a liquid crystal layer disposed between the substrates, wherein the alignment film is disposed between at least one of the substrates and the liquid crystal layer. The pair of substrates herein means a combination of an “upper substrate” and a “lower substrate”.

In the invention disclosed in Patent Literature 1, the antioxidant is introduced into the alignment film by adding a low-molecular-weight additive to the film.

In the invention disclosed in Patent Literature 1, the antioxidant having the chemical structure represented by the formula (1) of Patent Literature 1 is not chemically bonded to the polymer in the alignment film.

In the invention disclosed in Patent Literature 1, the antioxidant that is a low-molecular-weight additive easily dissolves into the liquid crystal layer. The antioxidant itself is thus a factor in decreasing the reliability.

When the antioxidant that is a low-molecular-weight additive dissolves into the liquid crystal layer while the polymer containing a photo-aligning functional group remains in the alignment film, even if the antioxidant has a radical-scavenging function, the antioxidant fails to sufficiently scavenge radicals generated from the photo-aligning functional group. As a result, as illustrated in FIG. 5, the radicals generated from the photo-aligning functional group may be transferred to liquid crystal molecules and then possibly ionized. The radical-scavenging effect is thus considered low as compared with that of the introduction of a radical-scavenging group into the polymer containing a photo-aligning functional group by a chemical bond.

When the antioxidant is a low-molecular-weight additive as in the invention disclosed in Patent Literature 1, the antioxidant is less likely to be uniformly distributed in the alignment film (in the case of a double-layer alignment film including a polymer containing a photo-aligning functional group and a polymer containing no photo-aligning functional group, only in the layer of the polymer containing a photo-aligning functional group). The antioxidant may be unevenly distributed or coagulates. Such uneven distribution decreases the radical-scavenging effect, causing a decrease in VHR. In addition, coagulation of the antioxidant causes uneven alignment of the liquid crystal, leading to a decrease in contrast ratio. Moreover, with the antioxidant being a low-molecular-weight additive, the probability of the antioxidant being distributed (concentrated) on the alignment film surface (interface between the liquid crystal layer and the alignment film) is low. Thus, the substantial concentration of the antioxidant (radical scavenger) that scavenges radicals in the liquid crystal layer is low. In contrast, the radical-scavenging group introduction into a polymer containing a photo-aligning functional group by a chemical bond does not cause uneven distribution of radical-scavenging groups, and allows uniform alignment. Since the radical-scavenging groups are only introduced into the polymer containing a photo-aligning functional group, the radical-scavenging groups can be distributed (concentrated) on the alignment film surface (interface between the liquid crystal layer and the alignment film), resulting in a high substantial concentration of the radical-scavenging group that scavenges radicals in the liquid crystal layer (e.g., FIG. 1 to FIG. 3).

In one aspect of the present invention, a quinone group is introduced into a polymer constituting the alignment film by a chemical bond. In contrast, Patent Literature 2 discloses benzoquinone only as a low-molecular-weight additive to add to an alignment film material. When the benzoquinone as a low-molecular-weight additive dissolves into the liquid crystal layer, the benzoquinone cannot sufficiently scavenge radicals generated from the photo-aligning functional groups in the photo-alignment film, failing to improve the reliability by radical scavenging. Thus, the effect of the use of benzoquinone is not fully exerted. Similarly, when the benzoquinone is unevenly distributed in the alignment film or coagulates, the benzoquinone cannot effectively scavenge radicals from the photo-aligning functional groups. Moreover, the probability of the polymerization-inhibiting component being distributed (concentrated) on the alignment film surface (interface between the liquid crystal layer and the alignment film) is low, resulting in a low substantial concentration of the polymerization-inhibiting component (radical scavenger) that scavenges radicals in the liquid crystal layer.

The dibutylhydroxytoluene (BHT) derivative mentioned in Patent Literature 2 as SMB has only one hydroxy group per molecule, and exhibits lower radical-scavenging ability than benzoquinone. It has been confirmed that the derivative has little reliability-improving effect on liquid crystal display devices (hereinafter also referred to as LCDs). Even if the BHT derivative scavenges a radical, a proton is released from the hydroxy group at the same time. If not scavenged, the released proton decreases the reliability of the LCD. In contrast, the carbonyl groups of benzoquinone do not release a proton in scavenging radicals. In addition, benzoquinone scavenges radicals more effectively because it has two radical scavenging sites per molecule.

### Advantageous Effects of Invention

The alignment film of the present invention can sufficiently reduce image sticking and stains in a liquid crystal display device. The polymer of the present invention, when used as an alignment film material, can sufficiently reduce image sticking and stains in a liquid crystal display device. In the liquid crystal display device of the present invention, image sticking and stains are sufficiently reduced.

### BRIEF DESCRIPTION OF DRAWINGS

FIG. 1 is a schematic cross-sectional view of the liquid crystal display device of the present invention.

FIG. 2 includes enlarged views of a portion indicated by dashed lines in FIG. 1, illustrating a long-term change of the portion.

FIG. 3 includes views illustrating a long-term change of a liquid crystal display device in which a low-molecular-weight compound is added to an alignment film material.

FIG. 4 is a schematic view of a polymer constituting a photo-alignment film, wherein the polymer contains a radical-scavenging group.

FIG. 5 is a schematic view of ion generation in cases where a radical-scavenging group is not chemically bonded to a polymer containing a photo-aligning functional group.

FIG. 6 is a schematic view of radical scavenging in cases where a radical-scavenging group is chemically bonded to a polymer containing a photo-aligning functional group.

FIG. 7 is a schematic view illustrating the mechanism of radical scavenging by a quinone functional group.

FIG. 8 is a schematic view of hydrogen bonds between a quinone-based additive and water molecules.

FIG. 9 is a schematic view illustrating a function of an antioxidant.

FIG. 10 is a schematic view illustrating prevention of oxidation using quinone.

FIG. 11 is a schematic view illustrating prevention of oxidation using quinone.

### DESCRIPTION OF EMBODIMENTS

Hereinafter, the present invention is described in more detail based on embodiments with reference to the drawings. The embodiments, however, are not intended to limit the scope of the present invention. The configurations of the embodiments may appropriately be combined or modified within the spirit of the present invention.

The photo-aligning functional group herein may be any functional group that generates a radical by absorbing light at a wavelength within the wavelength range of ultraviolet light and/or visible light.

A mode in which liquid crystal molecules are aligned in a direction substantially parallel to the main surfaces of the substrates when no voltage is applied is also referred to as a horizontal alignment mode. The phrase “substantially parallel” means, for example, the pre-tilt angle of liquid crystal molecules is 0° or greater and 5° or smaller relative to the main surfaces of the substrates. A mode in which liquid crystal molecules are aligned in a direction substantially perpendicular to the main surfaces of the substrates when no voltage is applied is also referred to as a vertical alignment mode. The phrase “substantially perpendicular” means, for example, the pre-tilt angle of liquid crystal molecules is 85° or greater and 90° or smaller. The term “room temperature” herein means a temperature of 15° C. or higher and 40° C. or lower.

The chemical bond herein usually means a covalent bond.

The present invention is applicable to both a horizontal alignment mode liquid crystal display device and a vertical alignment mode liquid crystal display device.

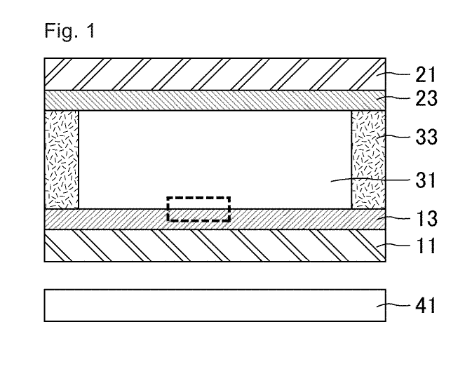

FIG. 1 is a schematic cross-sectional view of the liquid crystal display device of the present invention. As illustrated in FIG. 1, the liquid crystal display device includes a lower glass substrate 11, an upper glass substrate 21 facing the lower glass substrate 11, a liquid crystal layer 31 and a seal 33 disposed between the substrates, and alignment films 13 and 23. The alignment film 13 is disposed between the lower glass substrate 11 and the liquid crystal layer 31. The alignment film 23 is disposed between the upper glass substrate 21 and the liquid crystal layer 31. The seal 33 encloses the liquid crystal layer 31. The liquid crystal display device further includes a backlight 41 below (on the back surface side of) the lower glass substrate 11. The liquid crystal display device may further include a pair of polarizers, one of which is on the surface of the lower glass substrate 11 opposite to the liquid crystal layer 31 and the other of which is on the surface of the upper glass substrate 21 opposite to the liquid crystal layer 31.

The liquid crystal display device of the present invention includes components such as thin film transistor elements appropriately disposed on the lower glass substrate 11 which serves as a support substrate. The liquid crystal display panel of the present invention includes, for example, slit pixel electrodes on part of an insulating layer covering the components such as the thin film transistor elements and a common electrode on the upper glass substrate 21 as a support substrate. The material of the pixel electrodes and the common electrode to be favorably used is indium tin oxide (ITO) or indium zinc oxide (IZO). The liquid crystal display device of the present invention further includes components such as a color filter layer appropriately disposed on the upper glass substrate 21 (the display device may include a black matrix on the same layer). The color filter layer may be disposed on the lower glass substrate 11 instead of the upper glass substrate 21.

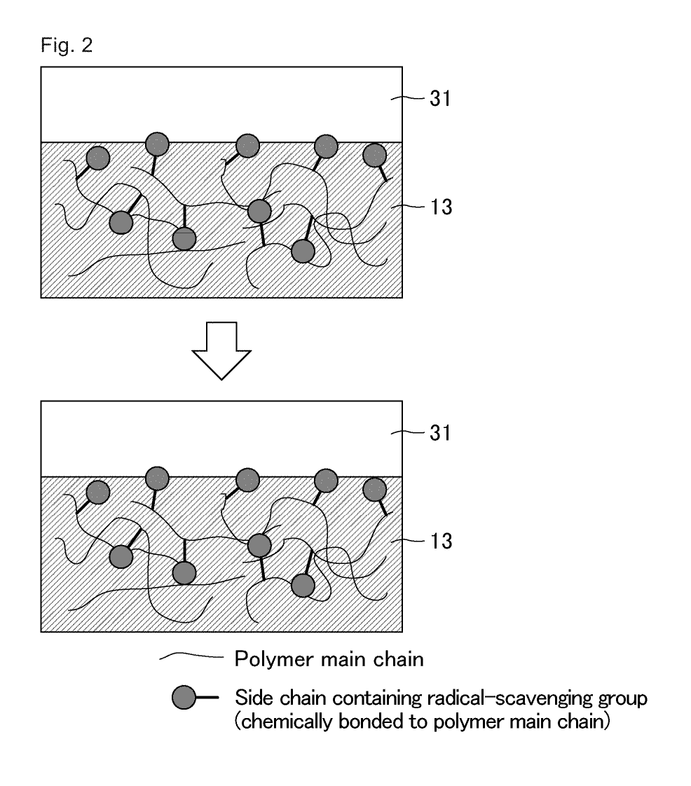

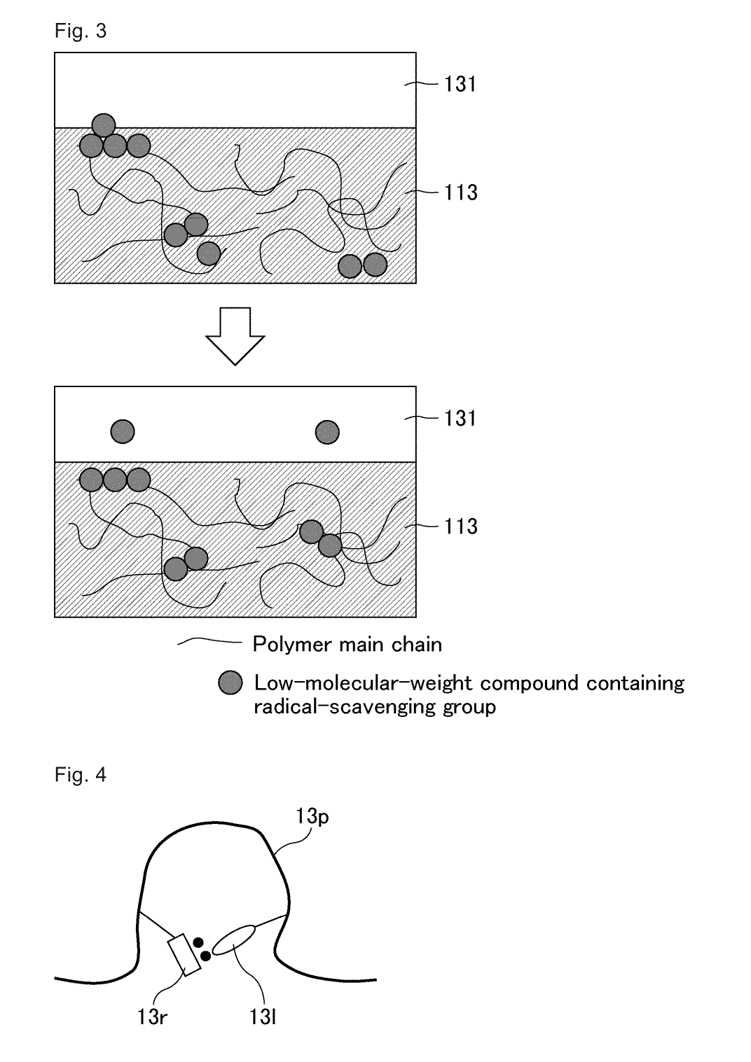

FIG. 2 includes enlarged views of a portion indicated by dashed lines in FIG. 1, illustrating a long-term change of the portion. FIG. 3 includes views illustrating a long-term change of a liquid crystal display device in which a low-molecular-weight compound is added to an alignment film material.

In the case of the present invention, as illustrated in FIG. 2, radical-scavenging groups are chemically bonded to the polymer in the alignment film 13. As a result, the states of the alignment film 13 and the liquid crystal layer 31 show no change even for a long time.

In cases where a low-molecular-weight compound containing a radical-scavenging group is added to the alignment film material, long lapse of time may possibly cause defects such as coagulation of the low-molecular-weight compound, uneven distribution of the low-molecular-weight compound on the surface of the alignment film 113, and dissolution of the low-molecular-weight compound which is easily soluble in liquid crystal into the liquid crystal layer 131 (for example, see FIG. 3).

In the present invention, a polymer into which a radical-scavenging group is introduced by a chemical bond is used as an alignment film material. The radical-scavenging group may be contained in a main chain or a side chain of the polymer. From the viewpoint of ease of polymer preparation, the radical-scavenging group is preferably contained in a side chain. This will be described in detail below.

For example, the amount of a monomer unit containing a radical-scavenging group according to the present invention to be introduced may fall within the range of 1 to 50 mol % relative to 100 mol % of the monomer units of the whole polymer.

### First Embodiment

In a first embodiment, a radical-scavenging group having a piperidine skeleton is introduced into a polymer containing a photo-aligning functional group (e.g., a polysiloxane, a polyvinyl) by a chemical bond so that the radical-scavenging group can effectively scavenge and deactivate a radical generated from the photo-aligning functional group.

FIG. 4 is a schematic view of a polymer constituting a photo-alignment film, wherein the polymer contains a radical-scavenging group. The radical-scavenging group introduced into the polymer containing a photo-aligning functional group by a chemical bond scavenges radicals generated due to absorption of backlight illumination by the photo-aligning functional group in the photo-alignment film (e.g., FIG. 4). In FIG. 4, a polymer portion 13p of the polymer constituting a photo-alignment film has a photo-aligning functional group 131 and a radical-scavenging group 13r. The radical-scavenging group 13r scavenges radicals generated from the photo-aligning functional group 131.

When the polymer containing a photo-aligning functional group is present in the alignment film (when not dissolved in the liquid crystal layer), the radical-scavenging group is relatively close to the radicals generated from the photo-aligning functional group. The radical-scavenging group thus easily scavenges the radicals, significantly decreasing the probability of the radicals being transferred to liquid crystal molecules. As a result, radical dissolution into the liquid crystal layer can be reduced.

When the polymer containing a photo-aligning functional group dissolves into the liquid crystal layer, the radical-scavenging group, which is chemically bonded to the polymer, simultaneously dissolves into the liquid crystal layer. The radical-scavenging group thus can effectively scavenge radicals from the photo-aligning functional group in the liquid crystal layer and radicals transferred from the photo-aligning functional group to liquid crystal molecules.

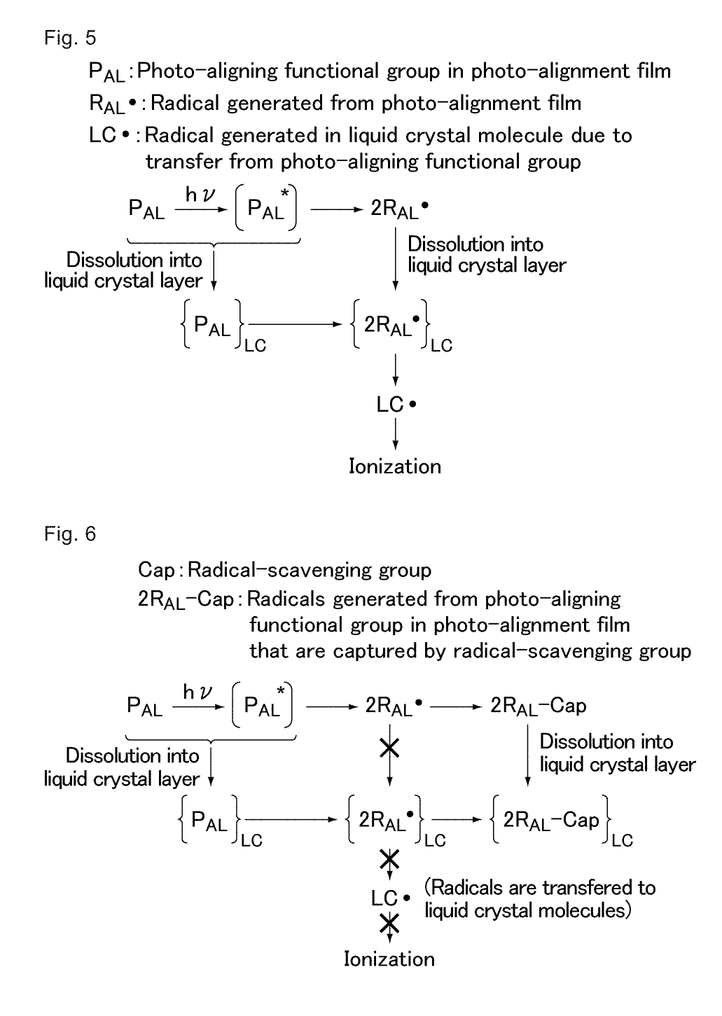

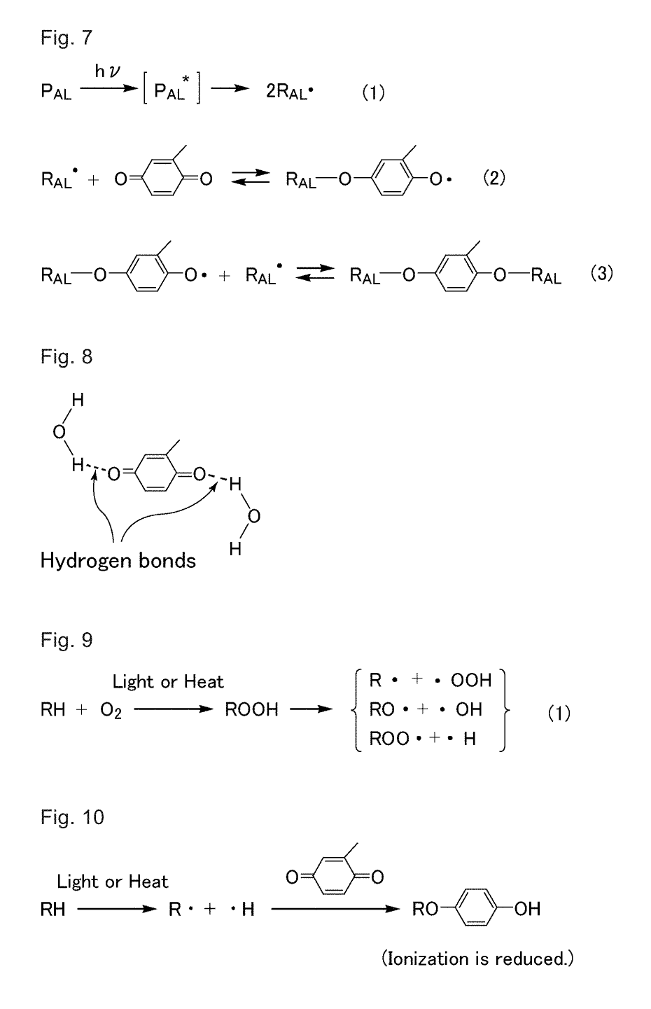

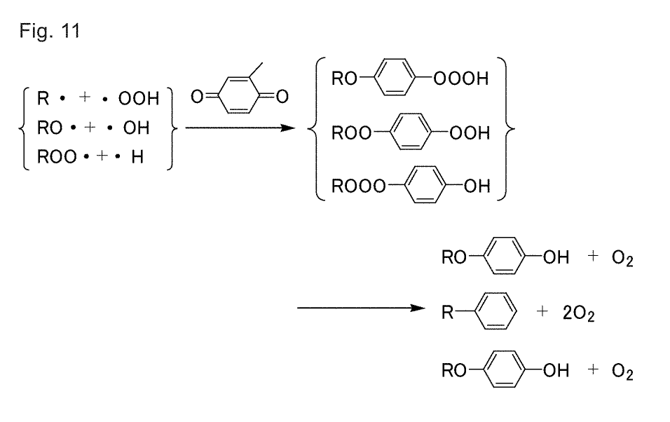

FIG. 5 is a schematic view of ion generation in cases where a radical-scavenging group is not chemically bonded to a polymer containing a photo-aligning functional group. FIG. 6 is a schematic view of radical scavenging in cases where a radical-scavenging group is chemically bonded to a polymer containing a photo-aligning functional group. As shown in FIG. 5, in cases where a radical-scavenging group is not introduced into a polymer containing a photo-aligning functional group by a chemical bond, radicals generated from the photo-aligning functional group are not sufficiently scavenged, either when the polymer containing a photo-aligning functional group is dissolved in the liquid crystal layer or when it is not dissolved in the liquid crystal layer. On the other hand, as shown in FIG. 6, in cases where a radical-scavenging group is introduced into a polymer containing a photo-aligning functional group by a chemical bond, radicals generated from the photo-aligning functional group can be sufficiently scavenged both when the polymer containing a photo-aligning functional group is dissolved in the liquid crystal layer and when it is not dissolved in the liquid crystal layer. This reduces the transfer of the radicals to liquid crystal molecules and the ionization thereof, thus reducing a decrease in VHR. As a result, the image sticking and display stains can be reduced.

In cases where a low-molecular-weight molecule containing a radical-scavenging group (hereinafter also referred to as a radical-scavenging molecule) is added to an alignment film material in such a manner that the molecule is not chemically bonded to the polymer in the film, the radical-scavenging molecule may remain inside the alignment film and only the polymer containing a photo-aligning functional group may dissolve into the liquid crystal layer. In such a case, the radical-scavenging molecule remaining in the alignment film is further less likely to scavenge radicals generated from the photo-aligning functional group in the polymer dissolved in the liquid crystal layer.

It may be possible to directly add a radical-scavenging molecule to a liquid crystal material (liquid crystal layer); however, since radical-scavenging groups having a piperidine skeleton generally have low solubility in liquid crystal, the radical-scavenging molecule may separate out of the liquid crystal layer. The separation may cause display unevenness. The addition of a radical-scavenging molecule to a liquid crystal material may also change the values of the physical properties of the liquid crystal material, thus possibly resulting in insufficient display performance. In addition, when in the presence of an acid such as carboxylic acid, the radical-scavenging groups having a piperidine skeleton are partially ionized under heat. The ionization of the radical-scavenging molecule decreases the VHR, causing image sticking and stains.

Meanwhile, when the radical-scavenging group having a piperidine skeleton is fixed to a polymer constituting the alignment film by a chemical bond, the liquid crystal layer does not contain a radical-scavenging group, so that the above problems are avoided (when the polymer is a polysiloxane, such fixation also provides the effect of reducing the dissolution of the polysiloxane into the liquid crystal layer).

For a double-layer alignment film composed of a lower layer including a polymer containing no photo-aligning functional group and an upper layer including a polymer containing a photo-aligning functional group, the radical-scavenging group having a piperidine skeleton may be introduced into the polymer containing a photo-aligning functional group or may be introduced into the polymer containing no photo-aligning functional group. Since the lower layer is also partially exposed at the surface layer of the alignment film, the radical-scavenging group introduced into the lower layer by a chemical bond also can scavenge radicals generated from the photo-aligning functional group.

In the double-layer alignment film composed of a lower layer including a polymer containing no photo-aligning functional group and an upper layer including a polymer containing a photo-aligning functional group, when the radical-scavenging groups are introduced only into the polymer containing a photo-aligning functional group, the radical-scavenging groups are concentrated on the alignment film surface (interface between the liquid crystal layer and the alignment film). This results in a substantially high concentration of the radical-scavenging group that scavenges radicals in the liquid crystal layer.

For example, the polymer having a main chain derived from a polysiloxane according to the first embodiment is preferably a polymer represented by the following formula (1):

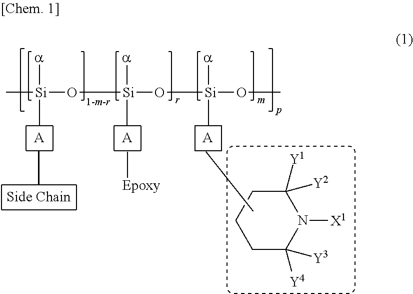

wherein X¹ is a hydrogen atom, an alkoxy group, an oxygen radical (O.), or a hydroxy group; Y¹, Y², Y³, and Y⁴ are the same as or different from each other and each a hydrogen atom or a monovalent or divalent organic group; Y¹ and Y² may be bonded to each other; Y³ and Y⁴ may be bonded to each other; Epoxy is a functional group having an epoxy group; as are each a hydrogen atom, an alkyl group, an alkoxy group, or a hydroxy group; m represents the amount of a monomer unit containing a radical-scavenging group having a piperidine skeleton to be introduced, and is greater than 0 and less than 1, preferably not greater than 0.3; r represents the amount of a monomer unit containing an epoxy group to be introduced, and is 0 or greater and less than 1; the sum of m and r is less than 1; p represents the degree of polymerization and is an integer of 1 or greater, preferably 10 or greater; Side Chains are the same as or different from each other and each a photo-aligning side chain or a vertically or horizontally aligning side chain other than the photo-aligning side chain; and A's are the same as or different from each other and each a direct bond or a divalent organic group. In the formula, the portion surrounded by the dashed line is a radical-scavenging group having a piperidine skeleton. Preferred embodiments of Side Chain are the same as those of Side Chain in the formula (9) and the formula (10), described later.

The polymer having a main chain derived from a polyvinyl according to the first embodiment is preferably a polymer represented by the following formula (2):

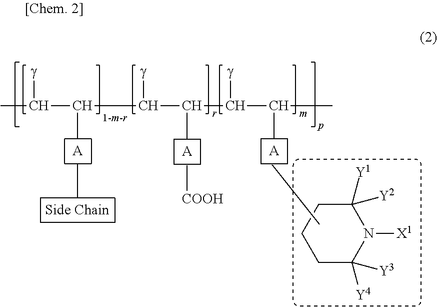

wherein X¹ is a hydrogen atom, an alkoxy group, an oxygen radical (O.), or a hydroxy group; Y¹, Y², Y³, and Y⁴ are the same as or different from each other and each a hydrogen atom or a monovalent or divalent organic group; Y¹ and Y² may be bonded to each other; Y³ and Y⁴ may be bonded to each other; Epoxy is a functional group having an epoxy group; γs are each a hydrogen atom or an alkyl group; m represents the amount of a monomer unit containing a radical-scavenging group having a piperidine skeleton to be introduced, and is greater than 0 and less than 1, preferably not greater than 0.3; r represents the amount of a monomer unit containing a carboxy group to be introduced, and is 0 or greater and less than 1; the sum of m and r is less than 1; p represents the degree of polymerization and is an integer of 1 or greater, preferably 10 or greater; Side Chains are the same as or different from each other and each a photo-aligning side chain or a vertically or horizontally aligning side chain other than the photo-aligning side chain; and A's are the same as or different from each other and each a direct bond or a divalent organic group. In the formula, the portion surrounded by the dashed line is a radical-scavenging group having a piperidine skeleton.

In the formula (1) or (2), suitable examples of the divalent organic group for A include those represented by the following formulae (3-1) to (3-9).

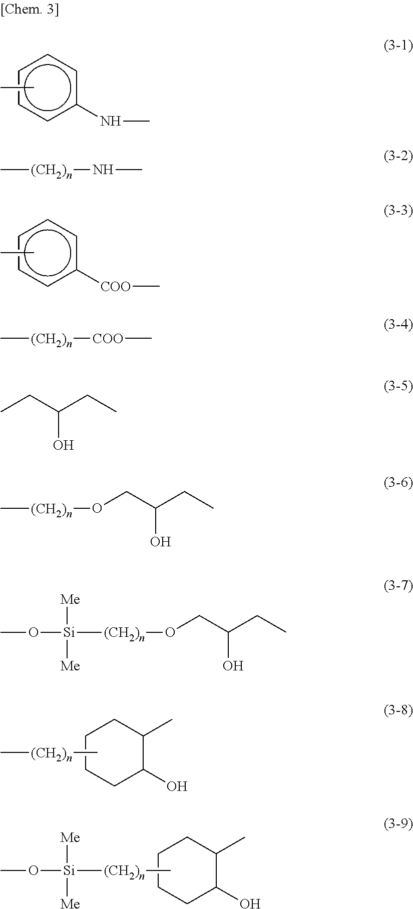

In the formulae (3-1) to (3-9), Me is a methyl group; and n is an integer of 0 to 30, preferably 1 to 20, more preferably 1 to 5.

Preferred specific examples of the structure of the polymer having a main chain derived from a polysiloxane include those represented by the following formula (4) and those represented by the following formula (5).

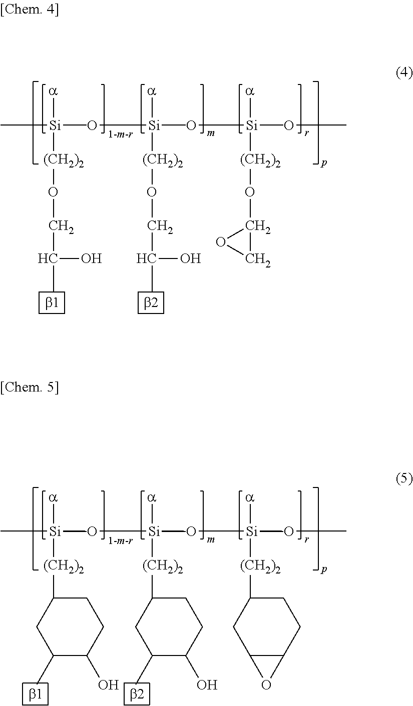

In the formula (4) and the formula (5), the numerical ranges of m, r, p, and α are as described above for the formula (1).

In the formula (4) and the formula (5), β1 is preferably a monovalent group represented by the following formula (6-1) or (6-2).

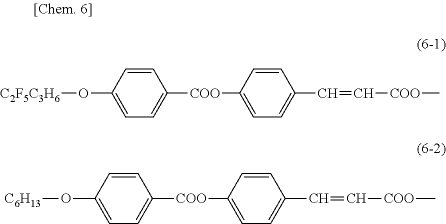

In the formula (4) and the formula (5), β2 is preferably a monovalent piperidine skeleton-containing group represented by the following formula (7-1) or (7-2).

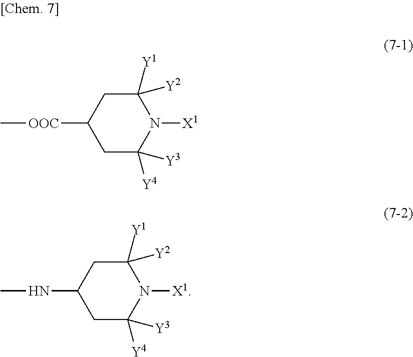

In the formula (7-1) and the formula (7-2), X¹ is a hydrogen atom, an alkoxy group, an oxygen radical (OS), or a hydroxy group; and Y¹, Y², Y³, and Y⁴ are each a methyl group.

Preferred specific examples of the structure of the polymer having a main chain derived from a polyvinyl include those represented by the following formula (8).

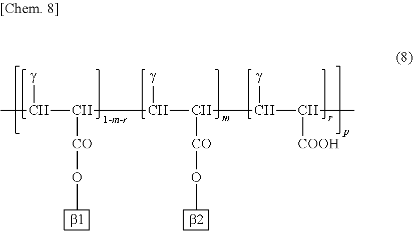

In the formula (8), the numerical ranges of m, r, p, and γ are as described above for the formula (2). β1 and β2 are as described above for the formula (4).

The alignment film according to the first embodiment of the present invention may include, for example, a polyamic acid represented by the following formula (9) or a polyimide represented by the following formula (10).

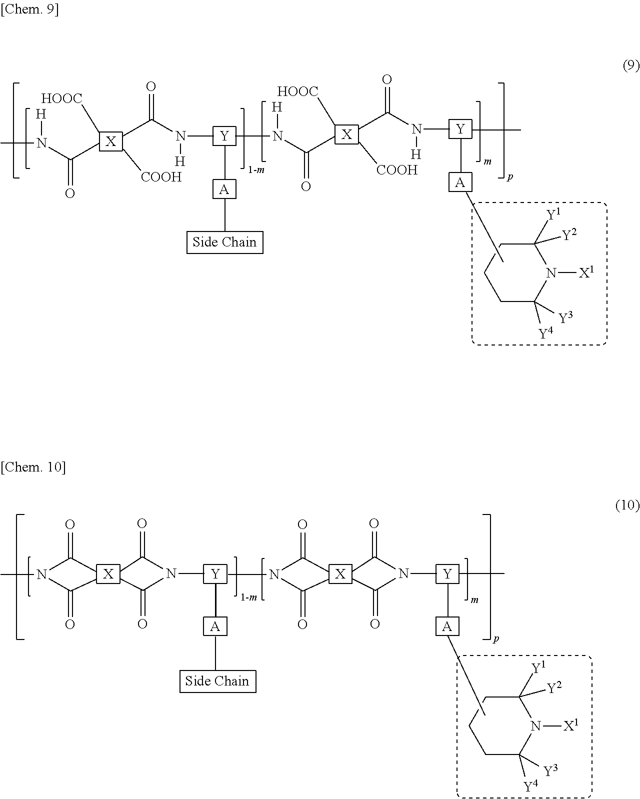

In each of the formula (9) and formula (10), X¹ is a hydrogen atom, an alkoxy group, an oxygen radical (O.), or a hydroxy group; Y¹, Y², Y³, and Y⁴ are the same as or different from each other and each a hydrogen atom or a monovalent or divalent organic group; Y¹ and Y² may be bonded to each other; Y³ and Y⁴ may be bonded to each other; m represents the amount of a monomer unit containing a radical-scavenging group having a piperidine skeleton to be introduced, and is greater than 0 and less than 1, preferably not greater than 0.3; p represents the degree of polymerization and is an integer of 1 or greater, preferably 10 or greater; Side Chains are the same as or different from each other and each a photo-aligning side chain or a vertically or horizontally aligning side chain other than the photo-aligning side chain; and A's are the same as or different from each other and each a direct bond or a divalent organic group. In the formula, the portion surrounded by the dashed line is a radical-scavenging group having a piperidine skeleton.

In each of the formula (9) and the formula (10), at least part of Side Chains is preferably a photo-aligning functional group, and a vertically or horizontally aligning functional group other than the photo-aligning functional group may separately be introduced thereinto. Side Chains each may be a monovalent group represented by any of the following formulae (11-1) to (11-8). These groups are for horizontal alignment films.

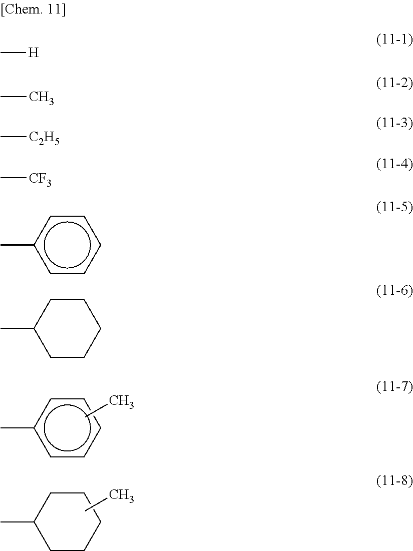

In each of the formula (9) and formula (10), Side Chains each may be a monovalent group represented by any of the following formulae (12-1) to (12-7). These groups are for vertical alignment films.

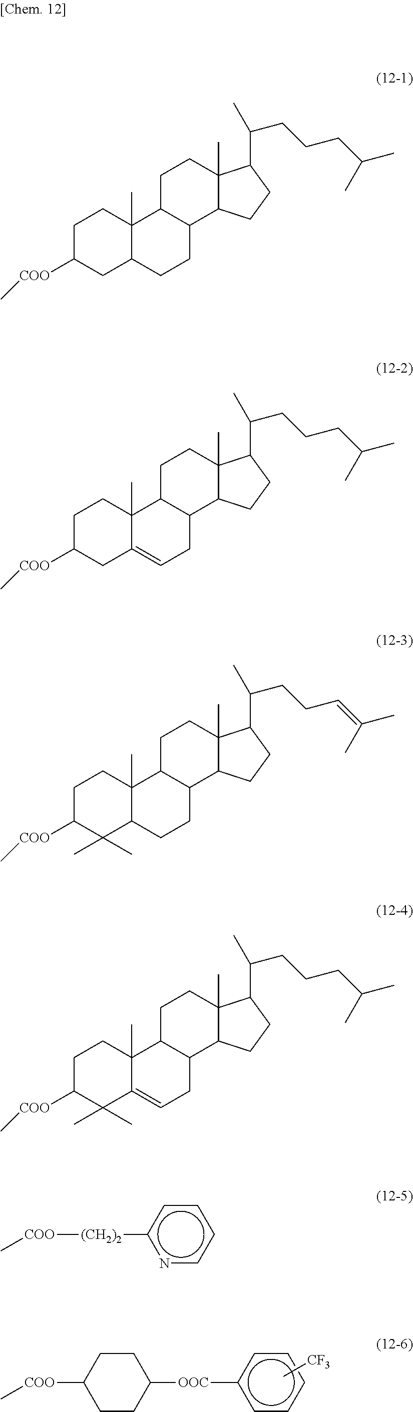

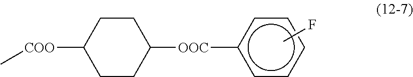

In each of the formula (9) and formula (10), Side Chains each may be a monovalent group represented by the following formula (13-1) or (13-2). These groups are for horizontal photo-alignment films.

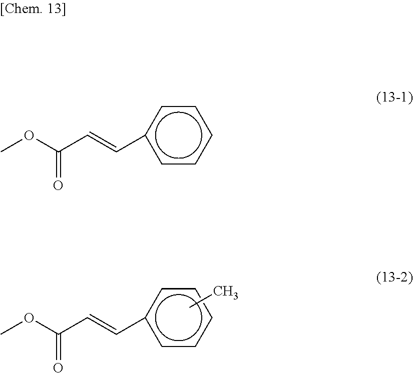

In each of the formula (9) and formula (10), Side Chains each may be a monovalent group represented by any of the following formulae (14-1) to (14-21). These groups are for vertical photo-alignment films.

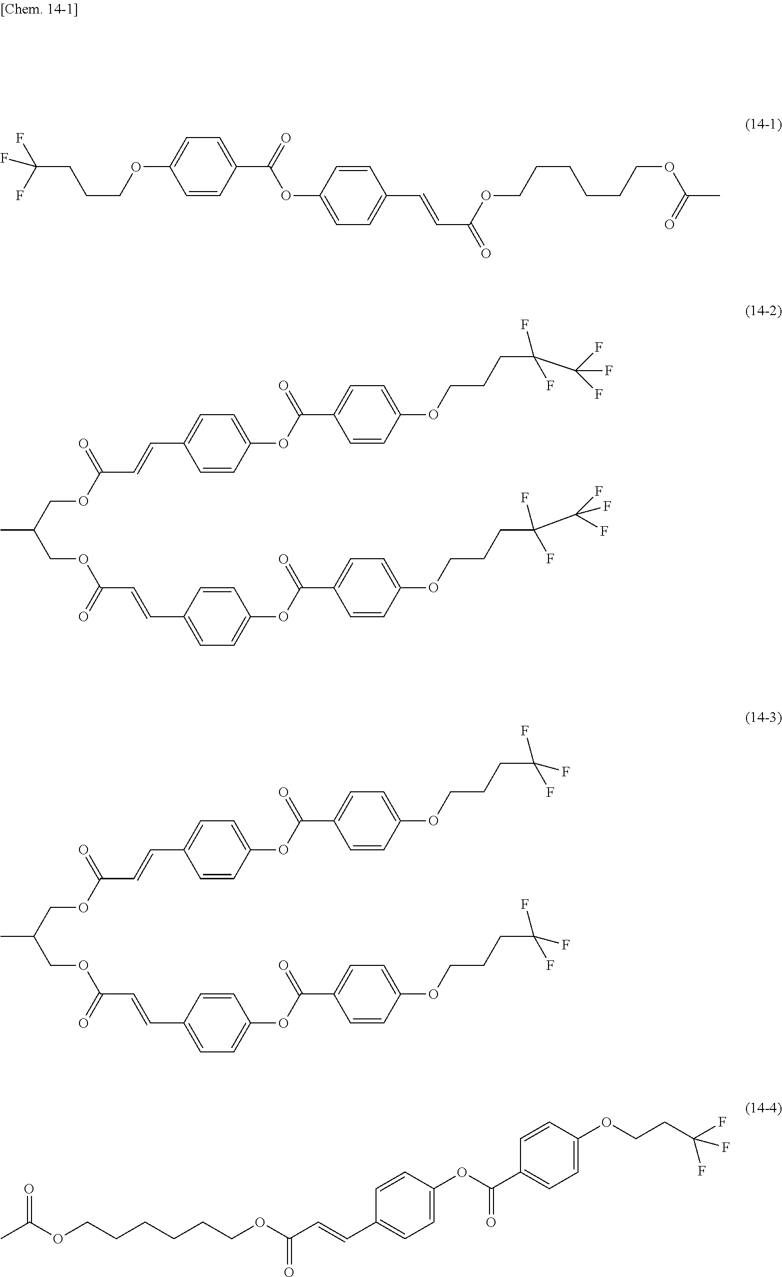

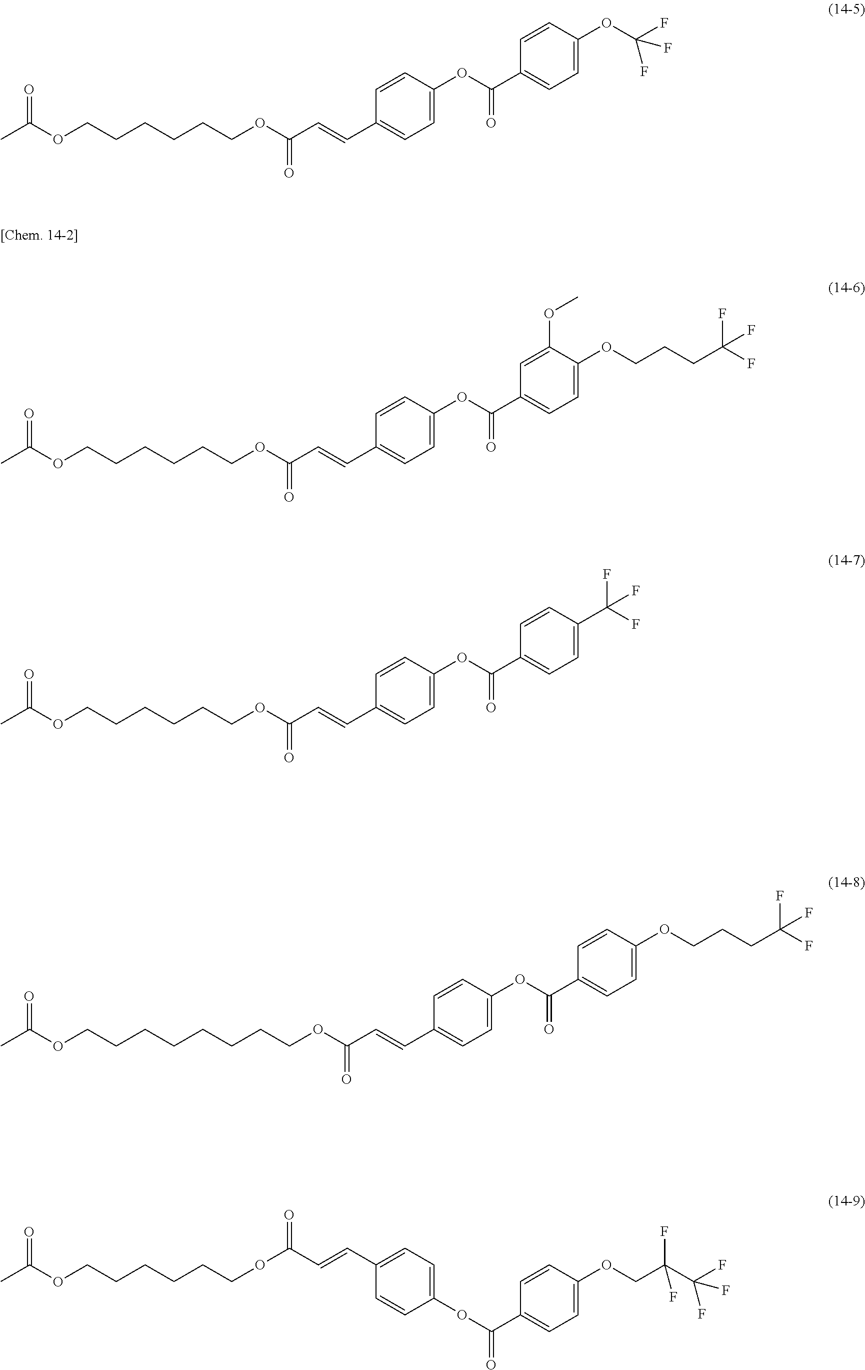 [SMILES: CC(=O)OCCCCCCOC(=O)/C=C/c1ccc(OC(=O)c2ccc(OC(F)(F)F)cc2)cc1 ; COc1cc(C(=O)Oc2ccc(/C=C/C(=O)OCCCCCCOC(C)=O)cc2)ccc1OCCCC(F)(F)F ; CC(=O)OCCCCCCOC(=O)/C=C/c1ccc(OC(=O)c2ccc(C(F)(F)F)cc2)cc1 ; CC(=O)OCCCCCCCCOC(=O)/C=C/c1ccc(OC(=O)c2ccc(OCCCC(F)(F)F)cc2)cc1 ; CC(=O)OCCCCCCOC(=O)/C=C/c1ccc(OC(=O)c2ccc(OCC(F)(F)C(F)(F)F)cc2)cc1]

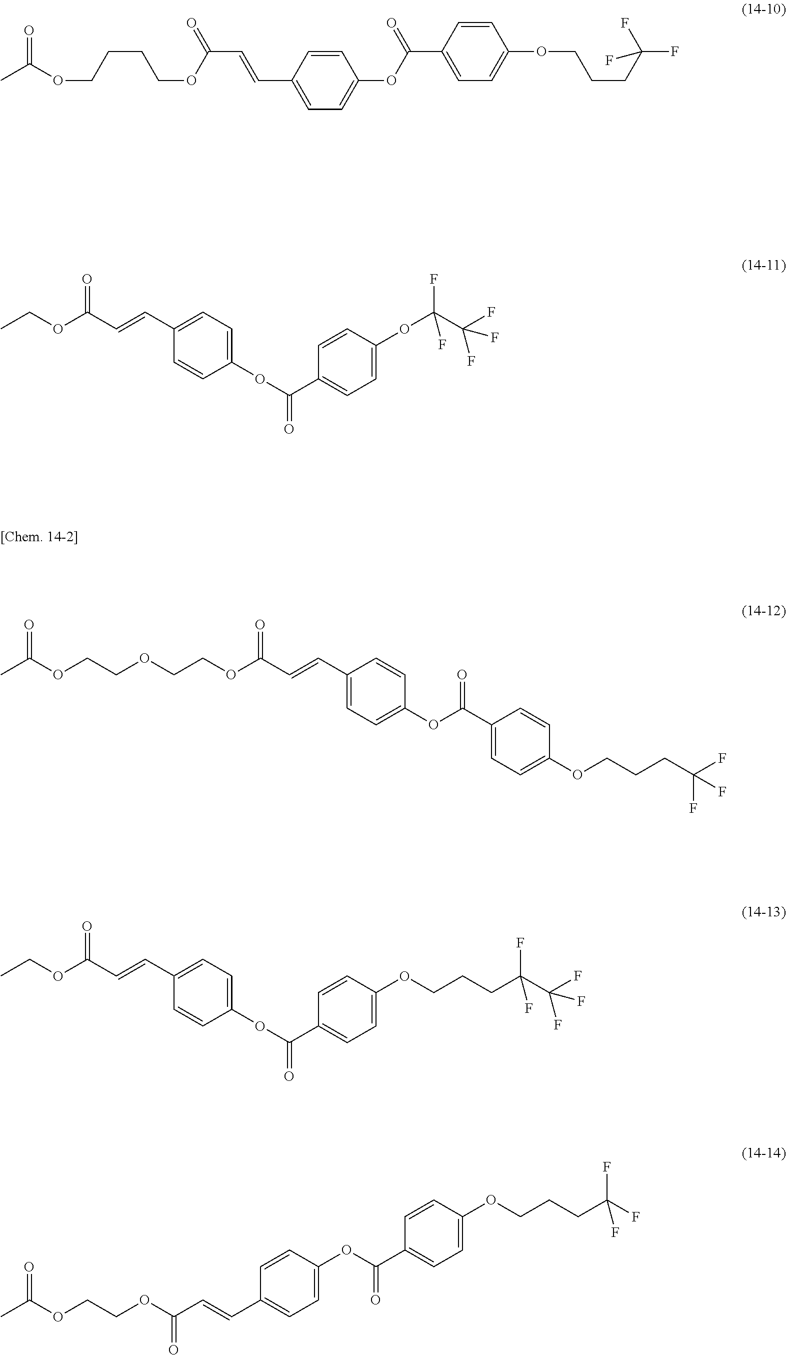 [SMILES: CC(=O)OCCCCOC(=O)/C=C/c1ccc(OC(=O)c2ccc(OCCCC(F)(F)F)cc2)cc1 ; CCOC(=O)/C=C/c1ccc(OC(=O)c2ccc(OC(F)(F)C(F)(F)F)cc2)cc1 ; CC(=O)OCCOCCOC(=O)/C=C/c1ccc(OC(=O)c2ccc(OCCCC(F)(F)F)cc2)cc1 ; CCOC(=O)/C=C/c1ccc(OC(=O)c2ccc(OCCCC(F)(F)C(F)(F)F)cc2)cc1 ; CC(=O)OCCOC(=O)/C=C/c1ccc(OC(=O)c2ccc(OCCCC(F)(F)F)cc2)cc1]

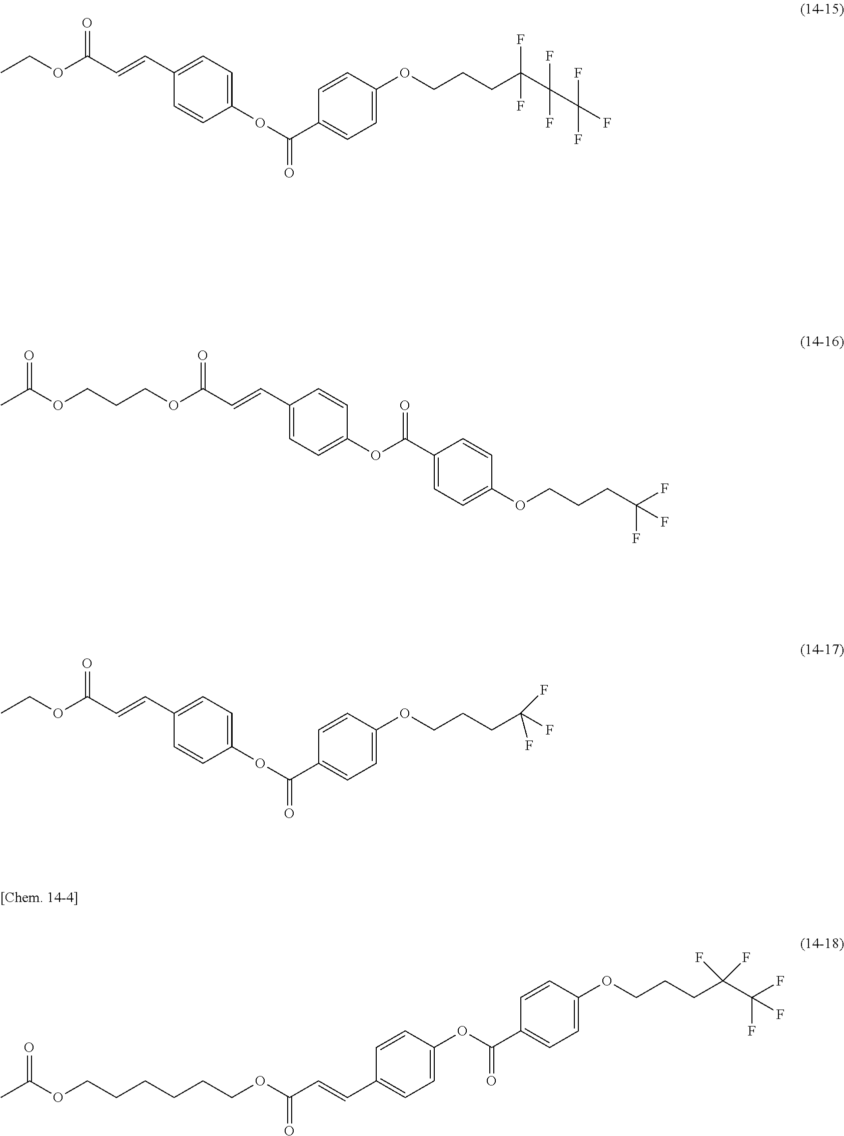 [SMILES: CCOC(=O)/C=C/c1ccc(OC(=O)c2ccc(OCCCC(F)(F)C(F)(F)C(F)(F)F)cc2)cc1 ; CC(=O)OCCCOC(=O)/C=C/c1ccc(OC(=O)c2ccc(OCCCC(F)(F)F)cc2)cc1 ; CCOC(=O)/C=C/c1ccc(OC(=O)c2ccc(OCCCC(F)(F)F)cc2)cc1 ; CC(=O)OCCCCCCOC(=O)/C=C/c1ccc(OC(=O)c2ccc(OCCCC(F)(F)C(F)(F)F)cc2)cc1]

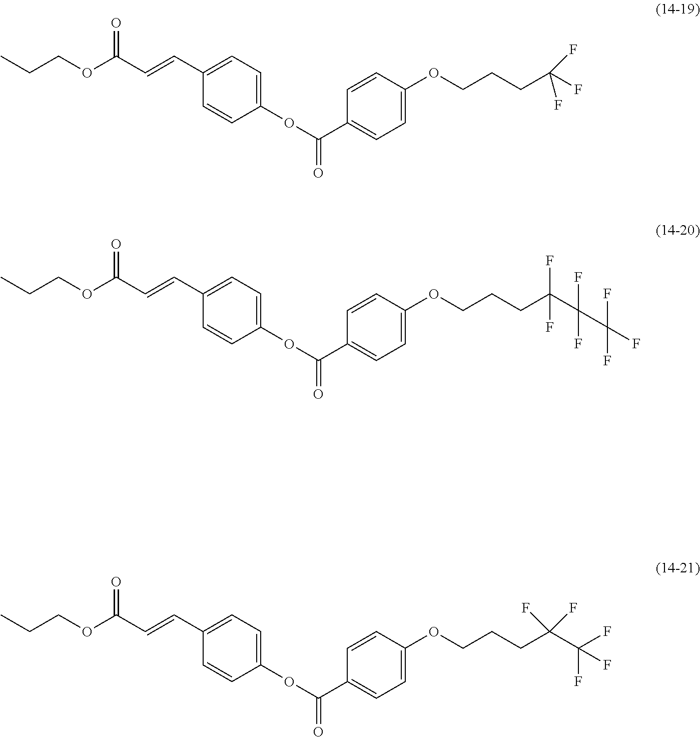 [SMILES: CCCOC(=O)/C=C/c1ccc(OC(=O)c2ccc(OCCCC(F)(F)F)cc2)cc1 ; CCCOC(=O)/C=C/c1ccc(OC(=O)c2ccc(OCCCC(F)(F)C(F)(F)C(F)(F)F)cc2)cc1 ; CCCOC(=O)/C=C/c1ccc(OC(=O)c2ccc(OCCCC(F)(F)C(F)(F)F)cc2)cc1]

In each of the formula (9) and formula (10), Xs are each preferably a tetravalent group represented by any of the following formulae (15-1) to (15-12). These groups can be used for both horizontal alignment films, which align liquid crystal molecules substantially parallel to the film surfaces, and vertical alignment films, which align liquid crystal molecules substantially perpendicular to the film surfaces.

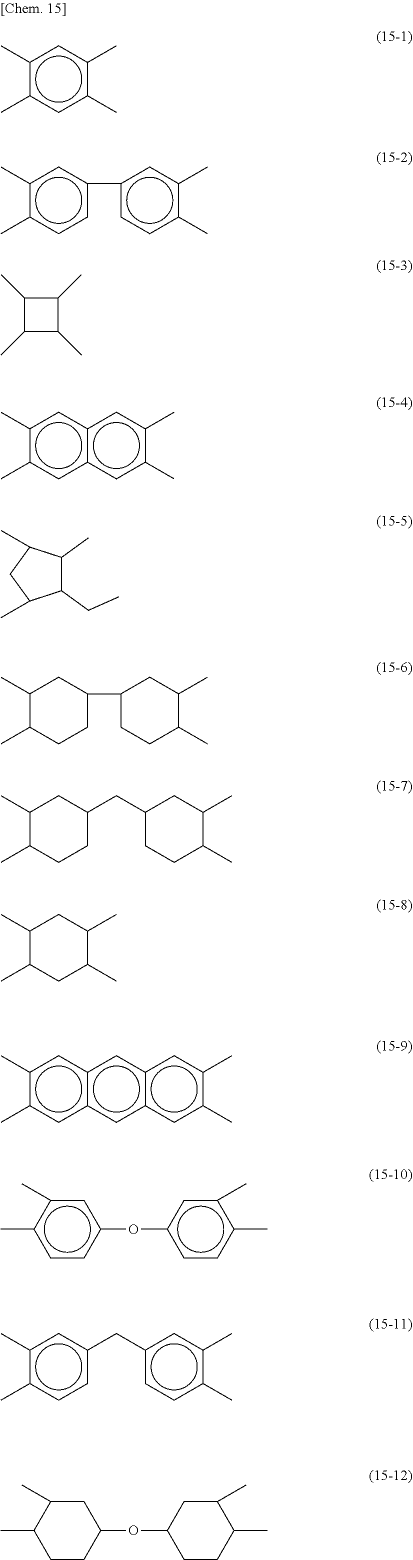

In each of the formula (9) and formula (10), Xs may be a tetravalent group represented by any of the following formulae (16-1) to (16-4). These groups can be used for both horizontal alignment films, which align liquid crystal molecules substantially parallel to the film surfaces, and vertical alignment films, which align liquid crystal molecules substantially perpendicular to the film surfaces.

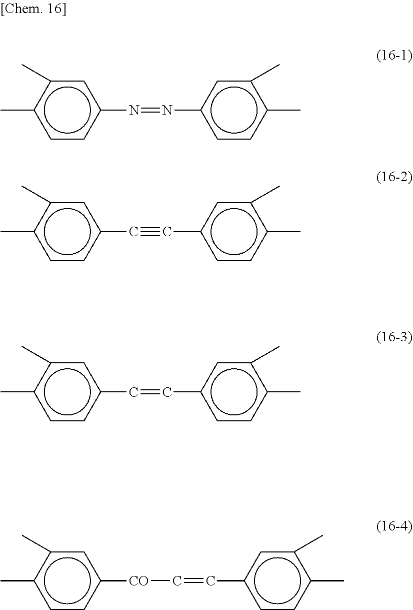

In each of the formula (9) and formula (10), Ys each may be a trivalent group represented by any of the following formulae (17-1) to (17-16). These groups can be used for both horizontal alignment films and vertical alignment films.

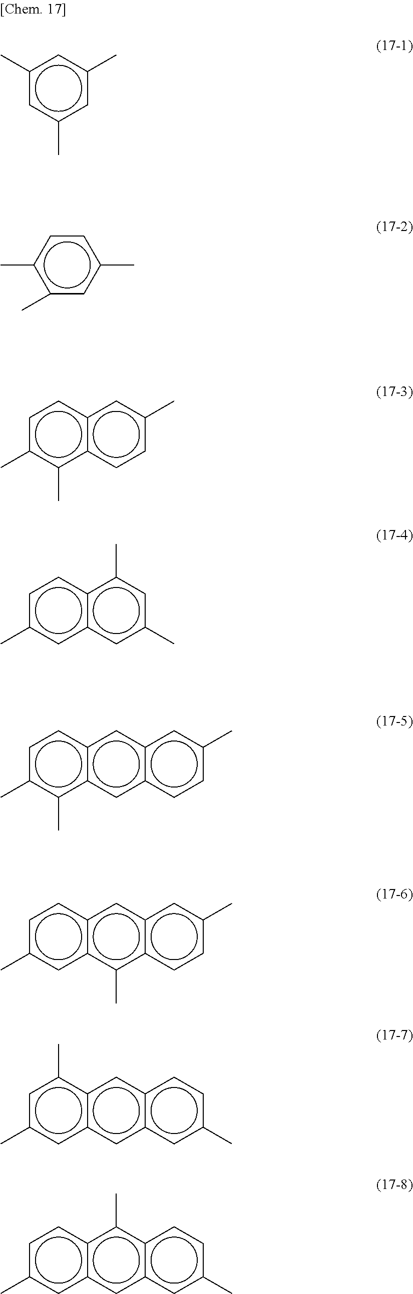

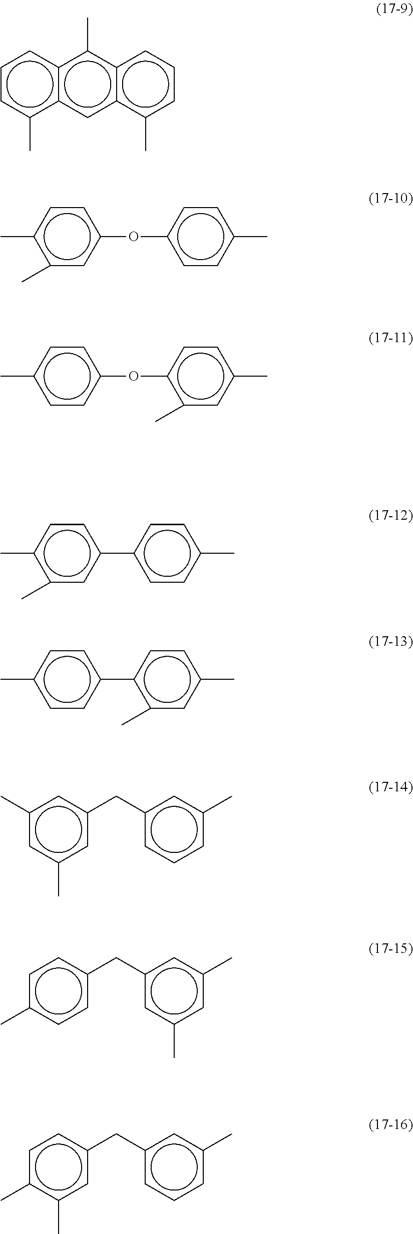

In each of the formula (9) and formula (10), Ys each may be a trivalent group represented by any of the following formulae (18-1) to (18-8). These groups can be used for any of photo-alignment films, horizontal alignment films other than the photo-alignment films, and vertical alignment films other than the photo-alignment films.

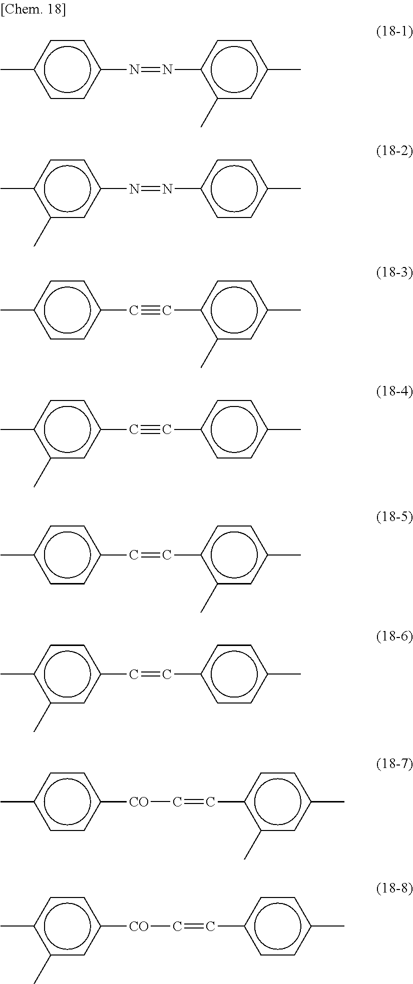

### Second Embodiment

In a second embodiment of the present invention, a radical-scavenging group having a benzoquinone (anthraquinone) skeleton is introduced into a polymer containing a photo-aligning functional group by a chemical bond.

Radical-scavenging groups having a quinone skeleton such as a benzoquinone (anthraquinone) skeleton have an effect similar to that of the radical-scavenging groups having a piperidine skeleton. In addition, radical-scavenging groups having a benzoquinone (anthraquinone) skeleton also have an antioxidative effect. They thus can prevent oxidation of a liquid crystal material or an alignment film material. The same can be said also when the polymer in the alignment film is a polymer other than a polysiloxane or a polyvinyl (e.g., a polyimide with a relatively low molecular weight or a polyimide with a low imidization ratio).

For example, the polymer having a main chain derived from a polysiloxane according to the second embodiment is preferably a polymer represented by the following formula (19-1) or the following formula (19-2):

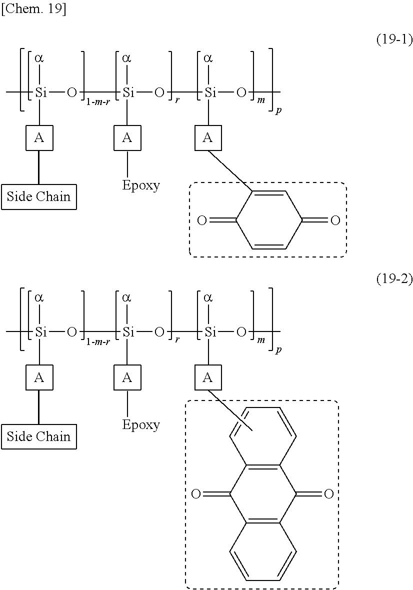

wherein Epoxy is a functional group having an epoxy group; αs are each a hydrogen atom, an alkoxy group, or a hydroxy group; m represents the amount of a monomer unit containing a radical-scavenging group having a quinone skeleton to be introduced, and is greater than 0 and less than 1, preferably not greater than 0.3; r represents the amount of a monomer unit containing an epoxy group to be introduced, and is 0 or greater and less than 1; the sum of m and r is less than 1; p represents the degree of polymerization and is an integer of 1 or greater, preferably 10 or greater; Side Chains are the same as or different from each other and each a photo-aligning side chain or a vertically or horizontally aligning side chain other than the photo-aligning side chain; and A's are the same as or different from each other and each a direct bond or a divalent organic group. In the formula, the portion surrounded by the dashed line is a radical-scavenging group having a quinone skeleton.

For example, the polymer having a main chain derived from a polyvinyl according to the second embodiment is preferably a polymer represented by the following formula (20-1) or the following formula (20-2):

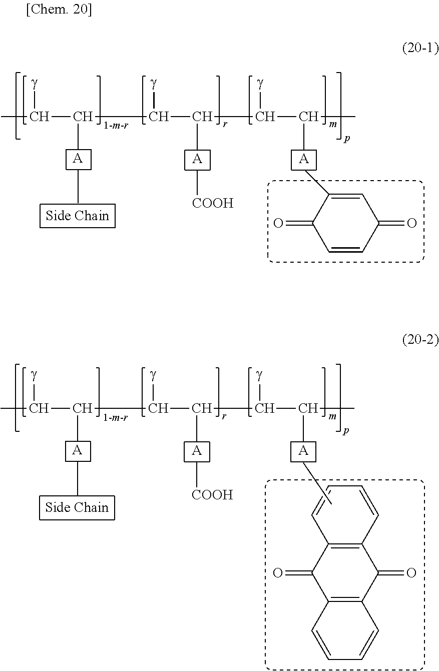

wherein γs are each a hydrogen atom or an alkyl group; m represents the amount of monomer unit containing a radical-scavenging group having a quinone skeleton to be introduced, and is greater than 0 and less than 1, preferably not greater than 0.3; r represents the amount of a monomer unit containing a carboxy group to be introduced, and is 0 or greater and less than 1; the sum of m and r is less than 1; p represents the degree of polymerization and is an integer of 1 or greater, preferably 10 or greater; Side Chains are the same as or different from each other and each a photo-aligning side chain or a vertically or horizontally aligning side chain other than the photo-aligning side chain; and A's are the same as or different from each other and each a direct bond or a divalent organic group. In the formula, the portion surrounded by the dashed line is a radical-scavenging group having a quinone skeleton.

More specific examples of the structure of the polymer having a main chain derived from a polysiloxane are the same as those represented by the formula (4) or the formula (5) except that β2 is a quinone group.

More specific examples of the structure of the polymer having a main chain derived from a polyvinyl are the same as those represented by the formula (8) except that β2 is a quinone group.

Suitable examples of the divalent organic group for A in the formula (19-1), the formula (19-2), the formula (20-1), or the formula (20-2) include those represented by the formulae (3-1) to (3-9).

The alignment film of the second embodiment of the present invention may contain, for example, a polyamic acid represented by the following formula (21-1) or the following formula (21-2) or a polyimide represented by the following formula (22-1) or the following formula (22-2).

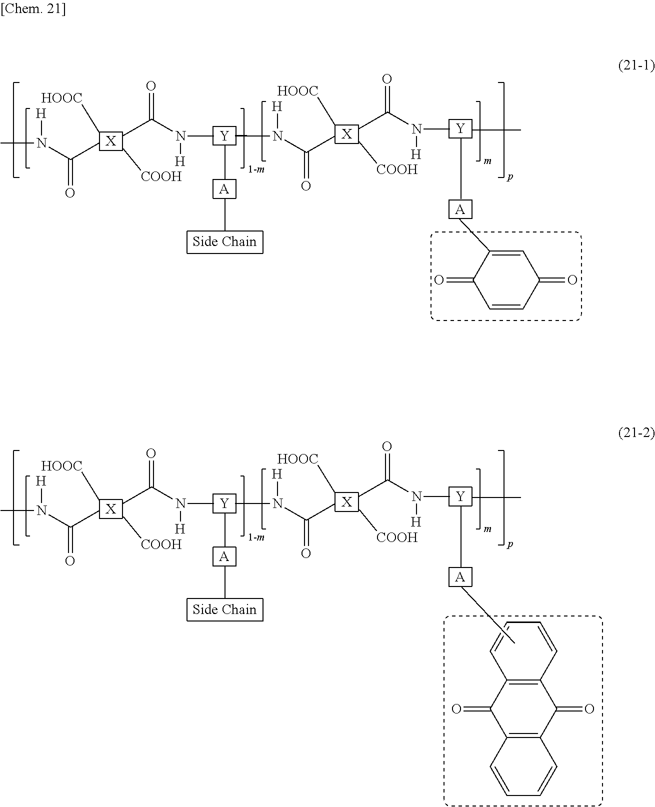

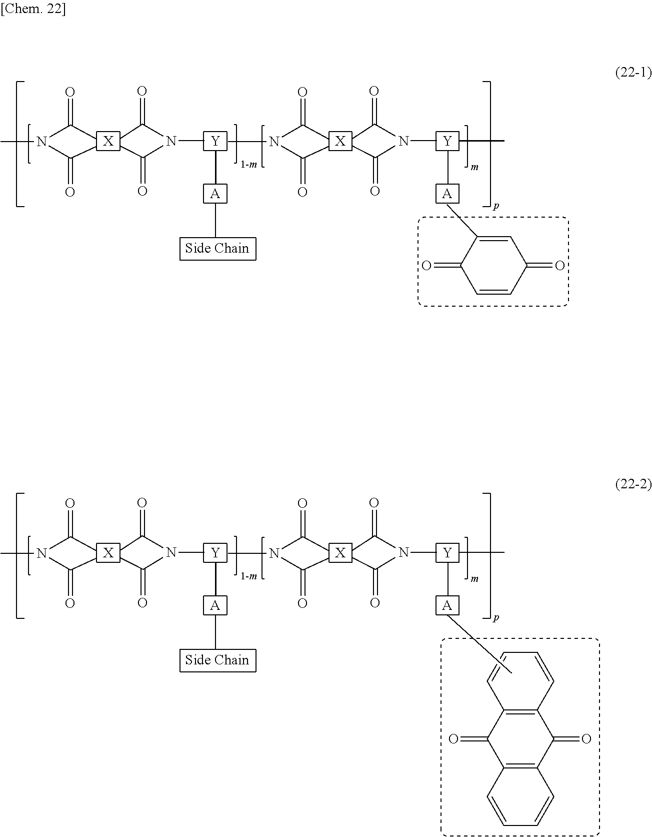

In each of the formula (21-1), the formula (21-2), the formula (22-1), and the formula (22-2), m represents the amount of a monomer unit containing a radical-scavenging group having a quinone skeleton to be introduced, and is greater than 0 and less than 1, preferably not greater than 0.3; p represents the degree of polymerization and is an integer of 1 or greater, preferably 10 or greater; Side Chains are the same as or different from each other and each a photo-aligning side chain or a vertically or horizontally aligning side chain other than the photo-aligning side chain; and A's are the same as or different from each other and each a direct bond or a divalent organic group. In the formula, the portion surrounded by the dashed line is a radical-scavenging group having a quinone skeleton.

In each of the formula (21-1), the formula (21-2), the formula (22-1), and the formula (22-2), X is the same as X described above for the formula (9) and the formula (10) and Y is the same as Y described above for the formula (9) and the formula (10).

In the following, examples corresponding to the first embodiment and the second embodiment will be described in sequence.

### Examples Corresponding to First Embodiment

The following will show one example of synthesis of a polysiloxane-based polymer containing, in a side chain, a radical-scavenging group having a piperidine skeleton.

(A) Thionyl chloride was added dropwise to a benzene solution (10 mL) containing 1 g (5 mmol) of 4-carboxy-TEMPO represented by the following formula (2), so that acid chloride (4.65 mmol, yield: 93%) represented by the following formula (3) was synthesized. Then, a benzene solution (5 mL) containing 0.55 g (2.5 mmol) of the acid chloride represented by the following formula (3) was added dropwise to a benzene solution (10 mL) containing 0.42 g (2.5 mmol) of ethyl 4-hydroxybenzoate and 0.5 g (5 mmol) of triethylamine at room temperature in a nitrogen atmosphere. The components were then reacted for two hours at room temperature. After the reaction completion, impurities were extracted with water and the resulting product was purified by column chromatography (toluene/ethyl acetate (4/1)). Thereby, 0.78 g (yield: 90%) of the target compound represented by the following formula (4) was obtained.

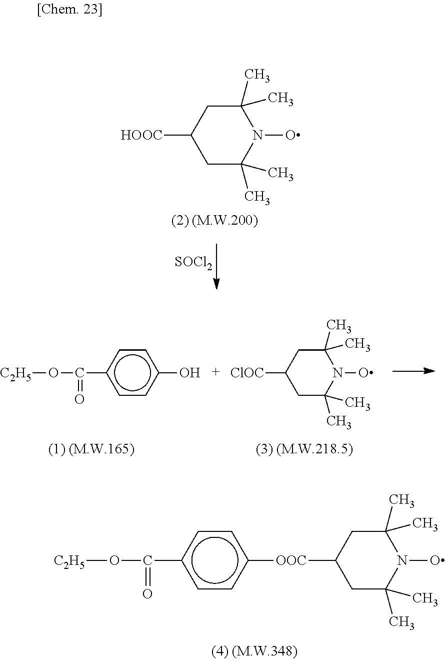

(B) A sodium hydroxide aqueous solution and then hydrochloric acid were added dropwise to a THF/methanol mixed solution (20 mL) containing 0.7 g (2 mmol) of the compound represented by the formula (4). The mixture was stirred for one hour, whereby a carboxylic acid compound represented by the following formula (5) was synthesized (0.61 g, 1.9 mmol).

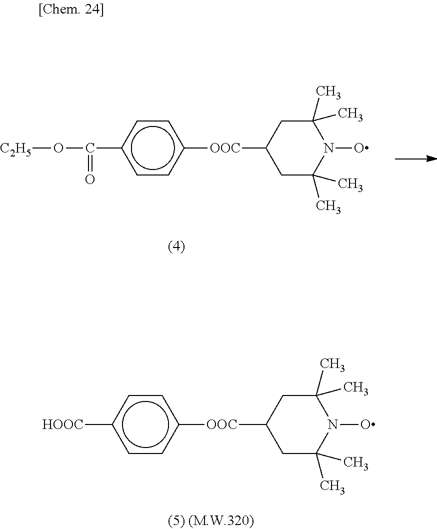

By repeating the processes (A) and (B), a compound represented by the following formula (6) was synthesized. In the formula, n is within the range of 1 to 5.

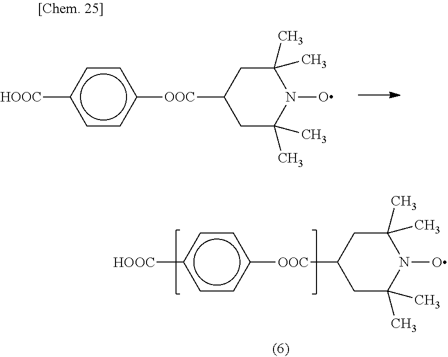

A toluene solution (10 mL) containing 0.6 g of a compound represented by the following formula (6) was added dropwise to a toluene solution (10 mL) containing 1 g of a polysiloxane represented by the following formula (7) (polysiloxane containing 50 mol % of a vertically aligning side chain having a cinnamate group as Side Chain, an example of Side Chain is provided below). The components were reacted for five hours at 70° C. After the reaction completion, dissolution and precipitation were carried out with ether as a poor solvent and NMP as a good solvent, and thereby a polysiloxane modified with a radical-scavenging group (about 30 mol % modification) (8) was obtained. In the following formulae, n is 1 and m is 0.3.

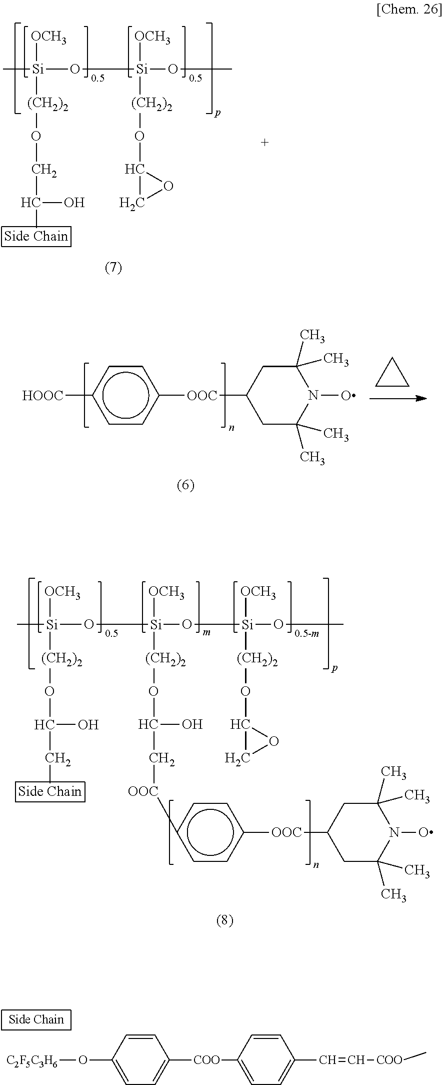

The following shows one example of synthesis of a polyvinyl-based polymer containing a radical-scavenging group having a piperidine skeleton.

To a 1-methylpyrrolidone solution (20 mL) containing 1.3 g of an acrylic acid polymer represented by the following formula (1) was added dropwise a 1-methylpyrrolidone solution (5 mL) containing 1.5 g (6.5 mmol) of 4-hydroxychalcone represented by the following formula (2) and 0.2 g (1.3 mmol) of 2,2,6,6-tetramethyl-4-piperidinol represented by the following formula (3). Subsequently, a 1-methylpyrrolidone solution (5 mL) containing 100 mg of N,N′-dicyclohexylcarbodiimide (DCC) and 100 mg of triethylamine (TEA) was added dropwise, and the components were reacted at 60° C. in a nitrogen atmosphere for 24 hours. A sodium hydroxide solution was then added dropwise to convert unreacted carboxy groups into sodium carboxylate, whereby precipitate was obtained. The precipitate was then recovered with an evaporator, and the recovered product was further subjected to dissolution and precipitation with methanol as a poor solvent and water as a good solvent. Finally, the sodium carboxylate was changed back to carboxylic acid by cation exchange chromatography, whereby a polyvinyl represented by the following formula (4) was obtained.

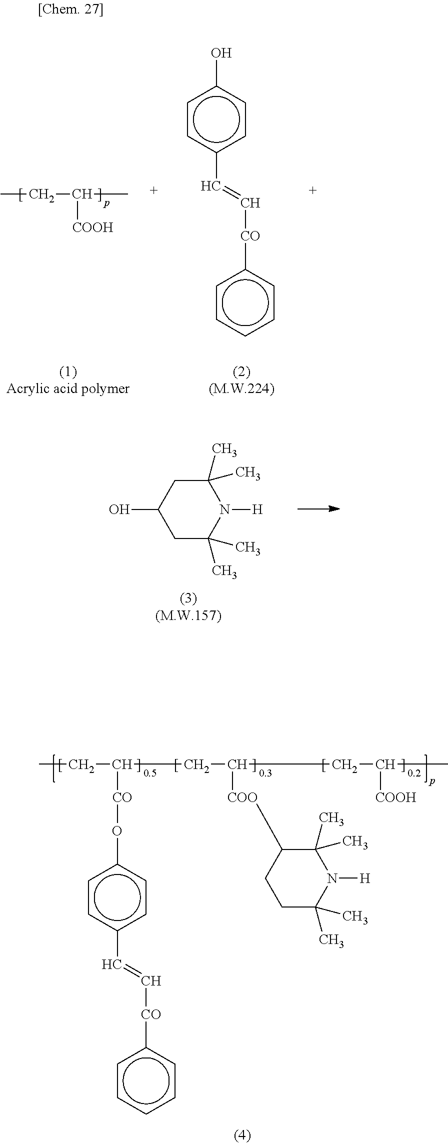

The following shows one example of synthesis of a diamine monomer containing a radical-scavenging group having a piperidine skeleton.

Five grams (22 mmol) of dinitrophenylacetic acid (1) was dissolved in 20 mL of benzene. Thionyl chloride was added dropwise thereto to synthesize dinitrophenylacetic acid chloride (2) (20 mmol, yield 91%). Subsequently, the benzene solution containing the dinitrophenylacetic acid chloride represented by the following formula (2) was added dropwise to a benzene (20 mL) solution containing 4.3 g (25 mmol) of 4-hydroxy-TEMPO and 3 g (30 mmol) of triethylamine at room temperature in a nitrogen atmosphere. The components were then reacted at room temperature for 10 hours. After the reaction completion, impurities were extracted with water and the resulting product was purified by column chromatography (toluene/ethyl acetate (4/1)). Thereby, 7.7 g (yield 75%) of the target compound represented by the following formula (4) was obtained.

Seven grams of the compound represented by the following formula (4) was dissolved in 20 mL of SOLMIX AP-I, and 1 g of Raney Ni was added thereto. The mixture was then put into an autoclave. The system was purged with hydrogen and left to stand at room temperature and 0.4 MPa overnight. Termination of the reaction was checked by HPLC, and the reaction liquid was filtered through cerite. The filtrate was concentrated until distillate was not observed any longer. The resulting crude liquid was distilled under reduced pressure, so that 4.82 g (83% yield) of a compound represented by the following formula (5) was obtained.

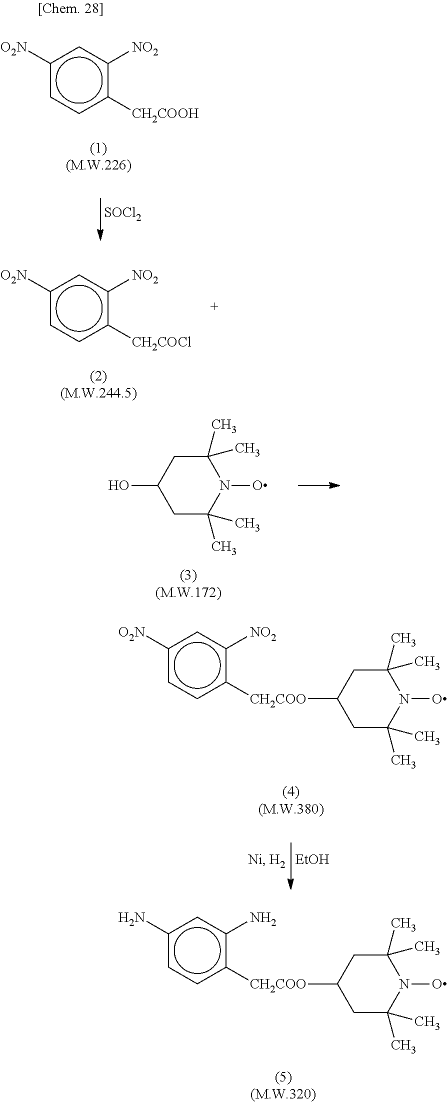

### Condensation Polymerization 1

The following shows one example of synthesis of a polyamic acid containing 10 mol % of a radical-scavenging group.

The following acid anhydride (0.10 mol) was added to a γ-butyrolactone solution containing the following diamine (0.09 mol) containing a photo-aligning functional group (azobenzene) and the following diamine (0.01 mol) containing a radical-scavenging group. They were reacted at 40° C. for 10 hours, so that a polyamic acid with a random structure was obtained.

The polyamic acid had a weight average molecular weight of 50,000 and a molecular weight distribution of 2.5.

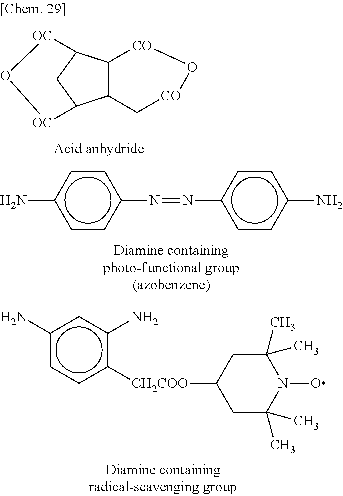

### Examples 1-1 to 1-4, Comparative Examples 1-1 and 1-2 (Vertical Photo-Alignment)

Polysiloxanes represented by the following formula were synthesized as alignment film materials.

In the polysiloxanes, n was fixed at 3 and m was as follows.

(1) m=0 (Comparative Example 1-1)
(2) m=0.1 (Example 1-1)
(3) m=0.2 (Example 1-2)
(4) m=0.3 (Example 1-3)
(5) m=0.4 (Example 1-4)
(6) m=0 (Comparative Example 1-2)

In Comparative Example 1-2, 5 wt % of 4-carboxy-TEMPO was added relative to the solute of the alignment film material.

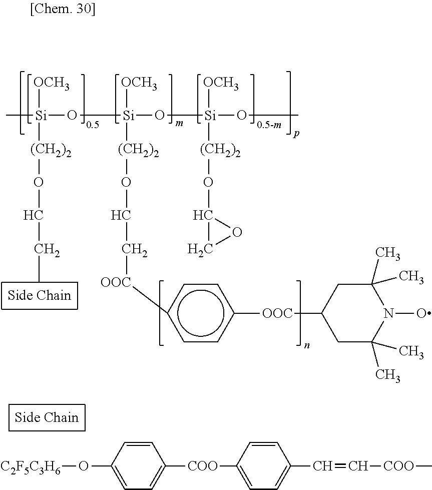

### (Production of Liquid Crystal Cell)

A pair of substrates, each including an ITO electrode, was provided. A mixed alignment agent of the corresponding cinnamate group-containing polysiloxane obtained in the above manner and a polyimide was applied to the substrates including an ITO electrode, followed by pre-baking at 90° C. for 5 minutes and then post-baking at 230° C. for 40 minutes. Thereby, double-layer alignment films were obtained, each of which contained the polymer having the chemical structure represented by the above formula in the surface layer. Then, the surfaces of the substrates each provided with an alignment film were irradiated with 20 mJ/cm² of linearly polarized ultraviolet light with a center wavelength of 330 nm, so that alignment treatment was performed. To one substrate was applied an ultraviolet-curable sealant (trade name: Photolec S-WB, Sekisui Chemical Co., Ltd.) in a predetermined pattern using a dispenser. Onto predetermined positions on the other substrate was dropped a negative liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an UV2A-mode liquid crystal cell was obtained.

### (High-Temperature Test on Backlight)

In order to evaluate the heat resistance of the liquid crystal cell, the liquid crystal cell was left to stand for 5000 hours on a 75° C. backlight, and the voltage holding ratio (VHR) and the contrast ratio were determined before and after the test. The VHR was determined at 1 V and 70° C. using a VHR measurement system Model 6254 (Toyo Corp.). The contrast ratio was determined at 25° C. using Topcon UL-1. The results are shown in Table 1. Table 1 shows the VHR and contrast ratio before and after the standing test on the 75° C. backlight.

TABLE 1

| | Before storage | | After 5000 h | |
|---|---|---|---|---|
| | | Contrast | | Contrast |
| | VHR (%) | ratio | VHR (%) | ratio |
| m = 0 | 99.5 | 4500 | 85.5 | 3400 |
| (Comparative Example 1-1) | | | | |
| m = 0.1 | 99.5 | 4500 | 96.0 | 4000 |
| m = 0.2 | 99.5 | 4500 | 98.0 | 4100 |
| m = 0.3 | 99.5 | 4500 | 99.0 | 4200 |
| m = 0.4 | 97.2 | 4400 | 93.3 | 3900 |
| m = 0 | 99.5 | 4200 | 90.5 | 3600 |
| 4-Carboxy-TEMPO added | | | | |
| (Comparative Example 1-2) | | | | |

In the case of the alignment film material containing the polysiloxane represented by the above formula with m=0 (Comparative Example 1-1), both the VHR and the contrast ratio greatly decreased after the 5000-hour high-temperature test. This is presumably because the cinnamate group-containing polysiloxane dissolved into the liquid crystal layer, and some cinnamate groups were converted into radicals and ionized due to backlight illumination. In the case where m was within the range of 0.1 to 0.3, the decrease in VHR and contrast ratio after the 5000-hour high-temperature test was small. This is presumably because, both in the polysiloxane remaining in the alignment film and in the polysiloxane dissolved in the liquid crystal layer, radicals generated from the cinnamate groups due to backlight illumination were effectively scavenged by the radical-scavenging groups, so that ionization was less likely to occur. In the case where m was 0.4, the initial VHR and contrast ratio were low. This is presumably because the introduction of the radical-scavenging groups into the polysiloxane decreased the amount of epoxy group-containing side chains, resulting in less crosslinking with the base polyimide, causing dissolution of part of the polysiloxane into the liquid crystal layer at an early stage.

The addition of 4-carboxy-TEMPO to the alignment film material with m=0 (Comparative Example 1-2) exhibited an improving effect on the VHR and contrast ratio after the 5000-hour standing as compared with no addition; the effect, however, was low as compared with that of the introduction of a radical-scavenging group into the cinnamate group-containing polysiloxane by a chemical bond. The low improving effect on the VHR and the contrast ratio is considered to be attributable to the fact that the average distance between the cinnamate group and the radical-scavenging molecule of the additive was presumably relatively large, and that the polysiloxane and 4-hydroxy-TEMPO have different rates of dissolution into the liquid crystal layer.

### Examples 1-5 to 1-10 (Vertical Photo-Alignment)

Polysiloxanes represented by the following formula were synthesized as alignment film materials.

In the synthesized polysiloxanes, m was fixed at 0.3 and n was as follows.

(1) n=0 (Example 1-5)
(2) n=1 (Example 1-6)
(3) n=2 (Example 1-7)
(4) n=3 (Example 1-8)
(5) n=4 (Example 1-9)
(6) n=5 (Example 1-10)

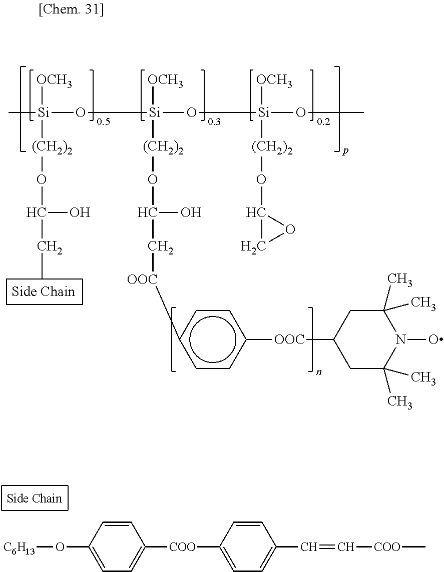

### (Production of Liquid Crystal Cell)

A pair of substrates, each including an ITO electrode, was provided. A mixed alignment agent of the corresponding cinnamate group-containing polysiloxane obtained in the above manner and a polyimide was applied to the substrates including an ITO electrode, followed by pre-baking at 90° C. for 5 minutes and then post-baking at 230° C. for 40 minutes. Thereby, double-layer alignment films were obtained, each of which contained the polymer having the chemical structure represented by the above formula in the surface layer. Then, the surfaces of the substrates each provided with an alignment film were irradiated with 20 mJ/cm² of linearly polarized ultraviolet light with a center wavelength of 330 nm, so that alignment treatment was performed. To one substrate was applied an ultraviolet-curable sealant (trade name: Photolec S-WB, Sekisui Chemical Co., Ltd.) in a predetermined pattern using a dispenser. Onto predetermined positions on the other substrate was dropped a negative liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an UV2A-mode liquid crystal cell was obtained.

### (High-Temperature Test on Backlight)

The voltage holding ratio (VHR) and the contrast ratio were measured before and after 5000-hour standing on a 75° C. backlight as in Example 1-1.

The results are shown in Table 2. Table 2 shows the VHR and contrast ratio before and after the standing test on the 75° C. backlight.

TABLE 2

| | Before storage | | After 5000 h | |
|---|---|---|---|---|
| | VHR (%) | Contrast ratio | VHR (%) | Contrast ratio |
| n = 0 | 99.5 | 4500 | 93.3 | 3900 |
| n = 1 | 99.5 | 4500 | 95.7 | 4000 |
| n = 2 | 99.5 | 4500 | 98.0 | 4100 |
| n = 3 | 99.5 | 4500 | 99.0 | 4200 |
| n = 4 | 99.5 | 4400 | 99.0 | 4150 |
| n = 5 | 99.5 | 4400 | 98.9 | 4100 |

In the case of the alignment film material containing the polysiloxane represented by the above formula with n=0, the VHR and the contrast ratio slightly decreased after the 5000-hour high-temperature test. Since the radical-scavenging group was close to the main chain, the radical-scavenging effect was presumably slightly lower.

In the case where n was within the range of 1 to 5, a high VHR of 98% or higher was maintained when n was 2 or greater. The radical scavenging effect increased with an increase in n, and is assumed to have almost reached saturation when n was 2 or 3.

### Examples 1-11 to 1-14, Comparative Example 1-3 (Horizontal Photo-Alignment IPS)

Polyvinyl-based polymers represented by the following formula were synthesized as alignment film materials.

In the synthesized polyvinyl-based polymers, 1-m-r was fixed at 0.5 and m was as follows.

(1) m=0 (Comparative Example 1-3)
(2) m=0.1 (Example 1-11)
(3) m=0.2 (Example 1-12)
(4) m=0.3 (Example 1-13)
(5) m=0.4 (Example 1-14)

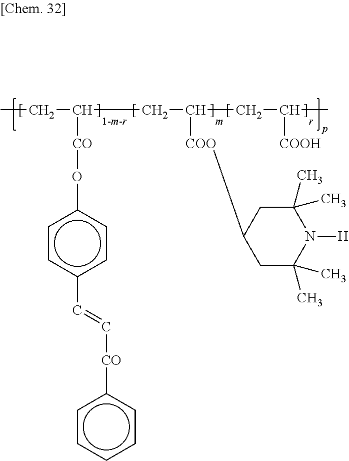

### (Production of Liquid Crystal Cell)

A substrate including a slit ITO electrode and a counter substrate including no electrode were provided. A mixed alignment agent of the corresponding chalcone group-containing polyvinyl-based polymer obtained in the above manner and a polyimide was applied to the substrates, followed by pre-baking at 90° C. for 5 minutes and then post-baking at 200° C. for 40 minutes. Thereby, double-layer alignment films were obtained, each of which contained the polymer having the chemical structure represented by the above formula in the surface layer. Then, the surfaces of the substrates each provided with an alignment film were irradiated with 2 J/cm² of linearly polarized ultraviolet light with a center wavelength of 365 nm, so that alignment treatment was performed. To one substrate (counter substrate including no electrode) was applied an ultraviolet-curable sealant (trade name: Photolec S-WB, Sekisui Chemical Co., Ltd.) in a predetermined pattern using a dispenser. Onto predetermined positions on the other substrate (substrate including a slit ITO electrode) was dropped a positive liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an IPS-mode liquid crystal cell was obtained.

### (High-Temperature Test on Backlight)

The voltage holding ratio (VHR) and the contrast ratio were measured before and after 5000-hour standing on a 75° C. backlight as in Example 1-1.

The results are shown in Table 3. Table 3 shows the VHR and contrast ratio before and after the standing test on the 75° C. backlight.

TABLE 3

| | Before storage | | After 5000 h | |
|---|---|---|---|---|
| | VHR (%) | Contrast ratio | VHR (%) | Contrast ratio |
| m = 0 | 98.6 | 1200 | 93.3 | 900 |
| m = 0.1 | 98.4 | 1200 | 96.1 | 1000 |
| m = 0.2 | 98.5 | 1050 | 97.2 | 1000 |
| m = 0.3 | 98.5 | 1000 | 97.7 | 1000 |
| m = 0.4 | 98.6 | 850 | 97.5 | 600 |

In the case of the alignment film material containing the polyvinyl-based polymer represented by the above formula with m=0 (Comparative Example 1-3), both the VHR and the contrast ratio greatly decreased after the 5000-hour high-temperature test. This is presumably because the chalcone group-containing polyvinyl-based polymer dissolved into the liquid crystal layer, and some chalcone groups were converted into radicals and ionized due to backlight illumination. In the case where m was within the range of 0.1 to 0.3, the decrease in VHR and the contrast ratio after the high-temperature test was small. This is presumably because, both in the polyvinyl-based polymer remaining in the alignment film and in the polyvinyl-based polymer dissolved in the liquid crystal layer, radicals generated from the chalcone groups due to backlight illumination were effectively scavenged by the radical-scavenging groups, so that ionization was less likely to be occur. In the case where m was 0.4, the initial contrast ratio was low, and the contrast ratio after 5000 hours was even lower. This is presumably because, since the radical-scavenging groups do not have alignment-imparting properties, the introduction of a large amount of bulky radical-scavenging groups into the polyvinyl-based polymer decreased the liquid crystal alignment properties.

### Examples 1-15 to 1-18, Comparative Example 1-4 (Horizontal Alignment FFS)

Azobenzene group-containing polyamic acids for photo-alignment represented by the following formula were synthesized as alignment film materials.

In the synthesized azobenzene group-containing polyamic acids for photo-alignment, m was as follows.

(1) m=0 (Comparative Example 1-4)
(2) m=0.1 (Example 1-15)
(3) m=0.2 (Example 1-16)
(4) m=0.3 (Example 1-17)
(5) m=0.4 (Example 1-18)

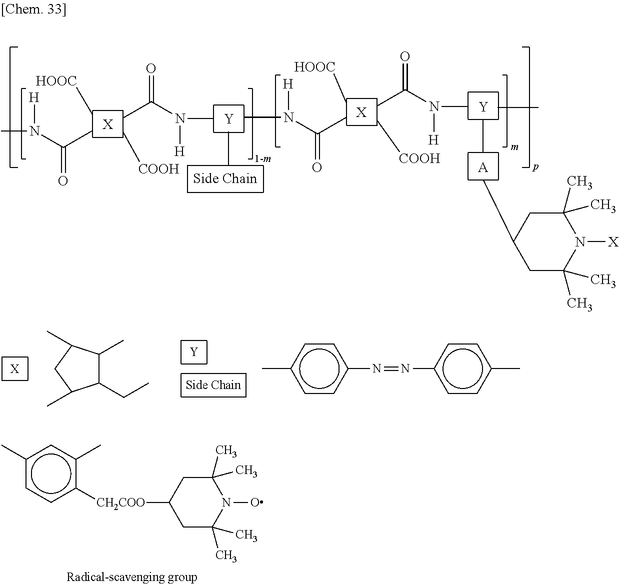

### (Production of Liquid Crystal Cell)

A substrate including an ITO electrode for an FFS-mode structure and a counter substrate including no electrode were provided. A mixed alignment agent of the corresponding azobenzene group-containing polyamic acid obtained in the above manner and a polyimide was applied to the substrates, followed by pre-baking at 90° C. for 5 minutes. Then, the surfaces of the substrates each provided with an alignment film were irradiated with 2 J/cm² of linearly polarized ultraviolet light with a center wavelength of 365 nm, so that alignment treatment was performed. This was followed by post-baking at 230° C. for 40 minutes. Thereby, double-layer alignment films were obtained, each of which contained the polymer having the chemical structure represented by the above formula in the surface layer. To one substrate (counter substrate including no electrode) was applied an ultraviolet-curable sealant (trade name: Photolec S-WB, Sekisui Chemical Co., Ltd.) in a predetermined pattern using a dispenser. Onto predetermined positions on the other substrate (substrate including an ITO electrode) was dropped a negative liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an FFS-mode liquid crystal cell was obtained.

### (High-Temperature Test on Backlight)

The voltage holding ratio (VHR) and the contrast ratio were measured before and after 5000-hour standing on a 75° C. backlight as in Example 1-1. The results are shown in Table 4.

TABLE 4

| | Before storage | | After 5000 h | |
|---|---|---|---|---|
| | VHR (%) | Contrast ratio | VHR (%) | Contrast ratio |
| m = 0 | 99.3 | 1100 | 84.3 | 810 |
| m = 0.1 | 99.4 | 1100 | 88.7 | 900 |
| m = 0.2 | 99.4 | 1000 | 91.3 | 920 |
| m = 0.3 | 99.4 | 1000 | 93.5 | 950 |
| m = 0.4 | 99.4 | 820 | 93.5 | 600 |

In the case of the alignment film material containing the polyamic acid represented by the above formula with m=0 (Comparative Example 1-4), both the VHR and the contrast ratio greatly decreased after the 5000-hour high-temperature test. This is presumably because the azobenzene group-containing polyamic acid dissolved into the liquid crystal layer, and some azobenzene groups were converted into radicals and ionized due to backlight illumination. In the case where m was within the range of 0.1 to 0.3, the decrease in VHR and the contrast ratio after the high-temperature test was small. This is presumably because, both in the polyamic acid remaining in the alignment film and in the polyamic acid dissolved in the liquid crystal layer, radicals generated from the azobenzene groups due to backlight illumination were effectively scavenged by the radical-scavenging groups, so that ionization was less likely to occur. In the case where m was 0.4, the initial contrast ratio was low, and the contrast ratio after 5000 hours was even lower. This is presumably because the introduction of a large amount of radical-scavenging groups into the polyamic acid decreased the amount of azobenzene-containing side chains, thus decreasing the liquid crystal alignment properties.

### Examples Corresponding to Second Embodiment

The following shows one example of synthesis of a polysiloxane-based polymer containing a benzoquinone functional group in a side chain.

First, thionyl chloride was added dropwise to a benzene solution (10 mL) containing 1.5 g (10 mmol) of 2-carboxy-1,4-benzoquinone represented by the following formula (2), so that acid chloride (8.8 mmol, yield 88%) represented by the following formula (3) was synthesized. Subsequently, a benzene solution (10 mL) containing 0.85 g (5 mmol) of benzoquinone-2-acid chloride represented by the following formula (3) was added dropwise to a benzene (10 mL) solution containing 0.84 g (5 mmol) of ethyl 4-hydroxybenzoate represented by the following formula (1) and 1 g (10 mmol) of triethylamine at room temperature in a nitrogen atmosphere. The components were then reacted at room temperature for five hours. After the reaction completion, impurities were extracted with water and the resulting product was purified by column chromatography (toluene/ethyl acetate (4/1)). Thereby, 1.25 g (yield 83%) of the target compound represented by the following formula (4) was obtained.

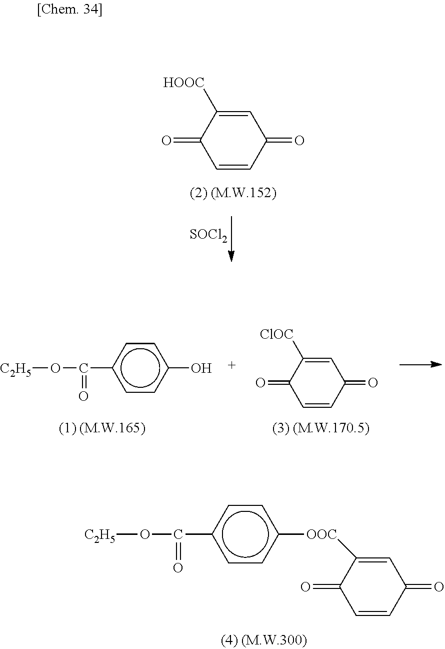

A sodium hydroxide aqueous solution and then hydrochloric acid were added dropwise to a THF/methanol mixed solution (20 mL) containing 1 g (3.3 mmol) of the compound represented by the formula (4). The mixture was stirred for three hours, and thereby a carboxylic acid compound represented by the following formula (5) was synthesized (0.6 g, 2.2 mmol).

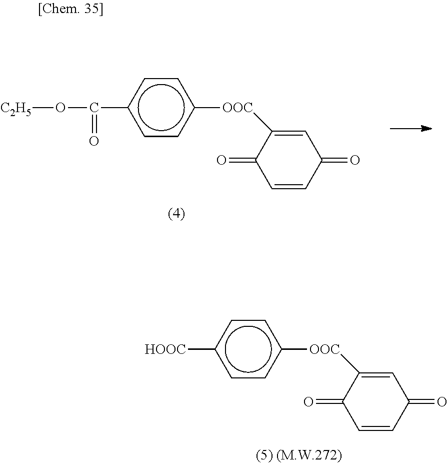

By repeating the processes (A) and (B), a compound represented by the following formula (6) was synthesized. In the formula, n is within the range of 1 to 5.

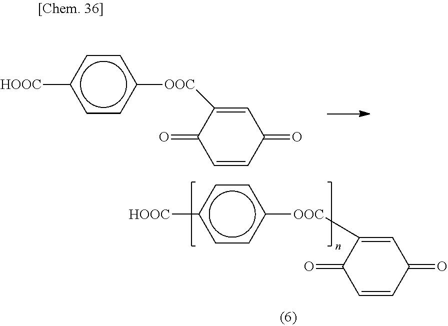

A toluene solution (20 mL) containing 1.5 g of a compound containing a radical-scavenging group represented by the following formula (6) was added dropwise to a toluene solution (20 mL) containing 3 g of a polysiloxane (containing 50 mol % of a vertically aligning side chain having a cinnamate group as Side Chain) represented by the following formula (7). The components were then reacted for five hours at 70° C. After the reaction completion, dissolution and precipitation were carried out with ether as a poor solvent and NMP as a good solvent, and thereby a polysiloxane modified with a radical-scavenging group (about 30 mol % modification) (8) was obtained. In the following formulae, m is 0.3 and n is 1.

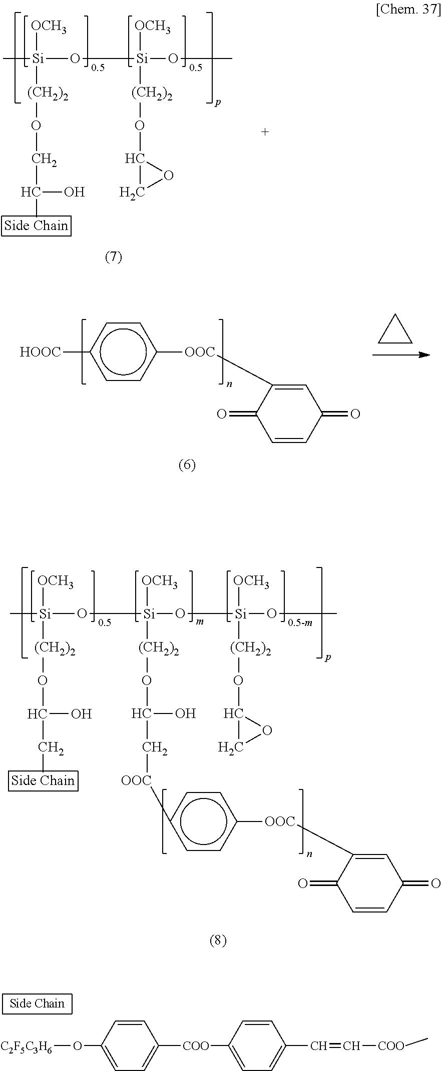

One example of synthesis of a polyvinyl-based polymer containing an anthraquinone functional group

To a 1-methylpyrrolidone solution (20 mL) containing 1.5 g of an acrylic acid polymer represented by the following formula (1) was added dropwise a 1-methylpyrrolidone solution (5 mL) containing 1.5 g (6.5 mmol) of 4-hydroxychalcone represented by the formula (2) and 0.3 g (1.3 mmol) of 2-hydroxyanthraquinone represented by the formula (3). Subsequently, a 1-methylpyrrolidone solution (5 mL) containing 100 mg of DCC (short for N,N′-dicyclohexylcarbodiimide) and 100 mg of TEA (short for triethylamine) were added dropwise. The components were then reacted at 60° C. in a nitrogen atmosphere for 24 hours. A sodium hydroxide solution was then added dropwise to convert unreacted carboxy groups into sodium carboxylate, whereby precipitate was obtained. The precipitate was then recovered with an evaporator, and the recovered product was further subjected to dissolution and precipitation with methanol as a poor solvent and water as a good solvent. Finally, the sodium carboxylate was changed back to carboxylic acid by cation exchange chromatography, whereby a polyvinyl-based polymer represented by the following formula (4) was obtained.

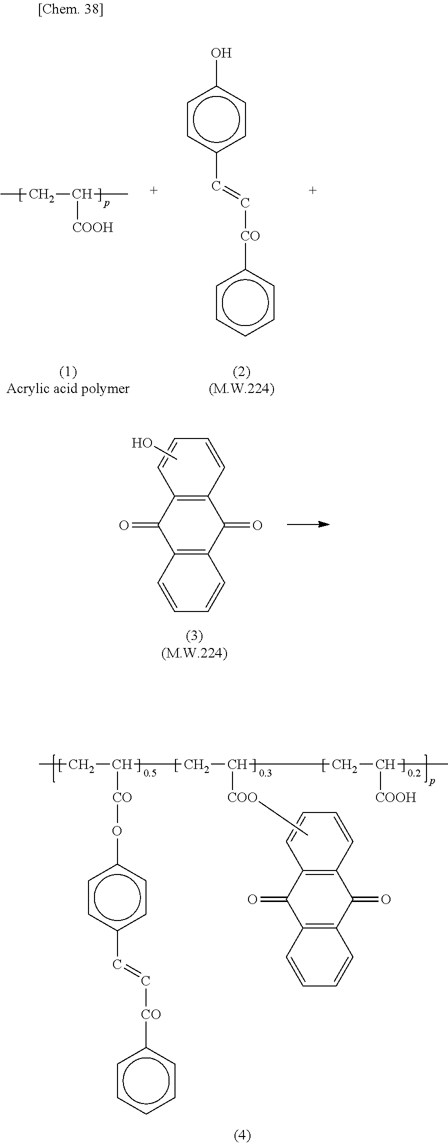

Example of synthesis of a diamine monomer containing a benzoquinone functional group

Five grams (22 mmol) of dinitrophenylacetic acid (1) was dissolved in 20 mL of benzene. Thionyl chloride was added dropwise thereto to synthesize dinitrophenylacetic acid chloride (2) (17 mmol, yield 77%). Subsequently, the benzene solution containing dinitrophenylacetic acid chloride represented by the following formula (2) was added dropwise to a benzene (20 mL) solution containing 1.86 g (15 mmol) of 2-hydroxybenzoquinone (3) and 3 g (30 mmol) of triethylamine at room temperature in a nitrogen atmosphere. The components were then reacted at room temperature for 10 hours. After the reaction completion, impurities were extracted with water and the resulting product was purified by column chromatography (toluene/ethyl acetate (4/1)). Thereby, 4.4 g (yield 88%) of the target compound represented by the following formula (4) was obtained.

Four grams of the compound represented by the following formula (4) was dissolved in 20 mL of SOLMIX AP-I, and 1 g of Raney Ni was added thereto. The mixture was then put into an autoclave. The system was purged with hydrogen and left to stand at room temperature and 0.4 MPa overnight. Termination of the reaction was checked by HPLC, and the reaction liquid was filtered through cerite. The filtrate was concentrated until distillate was not observed any longer. The resulting crude liquid was distilled under reduced pressure, so that 2.62 g (80% yield) of a compound represented by the following formula (5) was obtained.

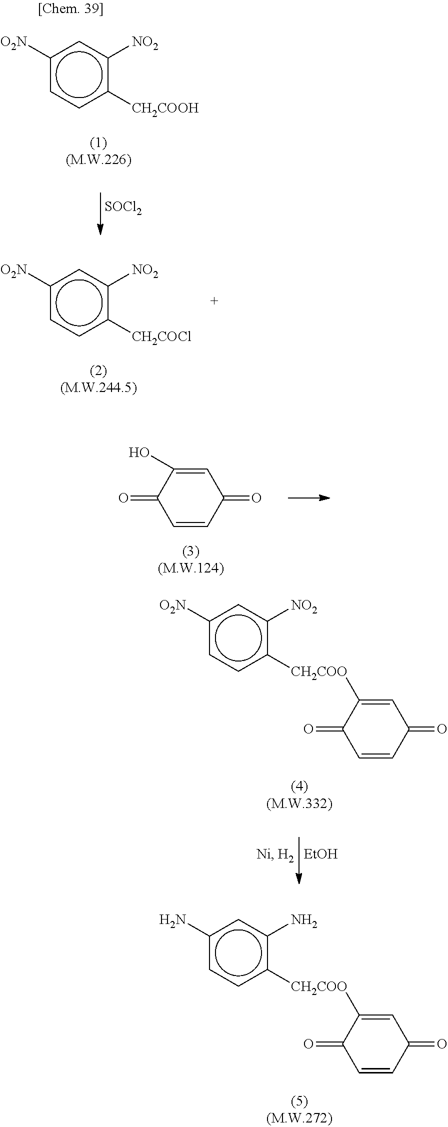

### Condensation Polymerization 2

The following shows an example of synthesis of a polyamic acid containing 10 mol % of a benzoquinone functional group.

The above acid anhydride (0.10 mol) was added to a γ-butyrolactone solution containing a diamine (0.09 mol) containing a photo-aligning functional group (azobenzene) and a diamine (0.01 mol) containing a benzoquinone functional group. They were reacted at 40° C. for 10 hours, so that a polyamic acid with a random structure was obtained. The polyamic acid had a weight average molecular weight of 40,000 and a molecular weight distribution of 2.2.

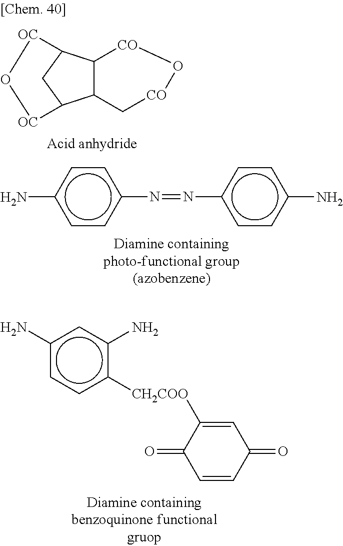

### Examples 2-1 to 2-4, Comparative Examples 2-1 and 2-2 (Vertical Photo-Alignment UV2A)

Polysiloxane-based polymers containing a benzoquinone group represented by the following formula were synthesized as alignment film materials.

In the polysiloxane-based polymers, n was fixed at 3 and m was as follows.

(1) m=0 (Comparative Example 2-1)
(2) m=0.1 (Example 2-1)
(3) m=0.2 (Example 2-2)
(4) m=0.3 (Example 2-3)
(5) m=0.4 (Example 2-4)
(6) m=0 (Comparative Example 2-2)

In Comparative Example 2-2, 5 wt % of benzoquinone was added relative to the solute of the alignment film material.

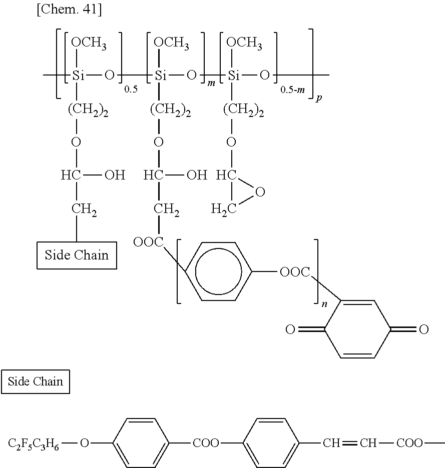

### (Production of Liquid Crystal Cell)

A pair of substrates, each including an ITO electrode, was provided. A mixed alignment agent of the corresponding cinnamate group-containing polysiloxane obtained in the above manner and a polyimide was applied to the substrates including an ITO electrode, followed by pre-baking at 90° C. for 5 minutes and then post-baking at 230° C. for 40 minutes. Thereby, double-layer alignment films were obtained, each of which contained the polymer having the chemical structure represented by the above formula in the surface layer. Then, the surfaces of the substrates each provided with an alignment film were irradiated with 20 mJ/cm² of linearly polarized ultraviolet light with a center wavelength of 330 nm, so that alignment treatment was performed. To one substrate was applied an ultraviolet-curable sealant (trade name: Photolec S-WB, Sekisui Chemical Co., Ltd.) in a predetermined pattern using a dispenser. Onto predetermined positions on the other substrate was dropped a negative liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an UV2A-mode liquid crystal cell was obtained.

### (High-Temperature Test on Backlight)

In order to evaluate the heat resistance of the liquid crystal cell, the liquid crystal cell was left to stand for 5000 hours on a 75° C. backlight, and the voltage holding ratio (VHR) and the contrast ratio were determined before and after the test. The VHR was determined at 1 V and 70° C. using a VHR measurement system Model 6254 (Toyo Corp.). The contrast ratio was determined at 25° C. using Topcon UL-1. The results are shown in Table 5. Table 5 shows the VHR and contrast ratio before and after the standing test on the 75° C. backlight.

TABLE 5

| | Before storage | | After 5000 h | |
|---|---|---|---|---|
| | VHR (%) | Contrast ratio | VHR (%) | Contrast ratio |
| m = 0 | 99.5 | 4500 | 85.5 | 3400 |
| (Comparative | | | | |
| Example 2-1) | | | | |
| m = 0.1 | 99.5 | 4500 | 93.3 | 3900 |
| m = 0.2 | 99.5 | 4500 | 95.7 | 4000 |
| m = 0.3 | 99.5 | 4500 | 96.6 | 4000 |
| m = 0.4 | 97.2 | 4400 | 94.7 | 3900 |
| m = 0 | 99.5 | 4200 | 88.5 | 3500 |
| Benzoquinone | | | | |
| added | | | | |
| (Comparative | | | | |
| Example 2-2) | | | | |

In the case of the alignment film material containing the polysiloxane represented by the above formula with m=0 (Comparative Example 2-1), both the VHR and the contrast ratio greatly decreased after the 5000-hour high-temperature test. This is presumably because the cinnamate group-containing polysiloxane dissolved into the liquid crystal layer, and some cinnamate groups were converted into radicals and ionized due to backlight illumination. In the case where m was within the range of 0.1 to 0.3, the decrease in VHR and the contrast ratio after the high-temperature test was small. This is presumably because, both in the polysiloxane remaining in the alignment film and in the polysiloxane dissolved in the liquid crystal layer, radicals generated from the cinnamate groups due to backlight illumination were effectively scavenged by the benzoquinone functional groups, so that ionization was less likely to occur. In the case where m was 0.4, the initial VHR and contrast ratio were low. This is presumably because the introduction of the benzoquinone functional groups into the polysiloxane decreased the amount of epoxy group-containing side chains, resulting in less crosslinking with the base polyimide, causing dissolution of part of the polysiloxane into the liquid crystal layer at an early stage.

The addition of benzoquinone, a low-molecular-weight molecule, to the alignment film material with m=0 (Comparative Example 2-2) exhibited a slight improving effect on the VHR and contrast ratio after 5000 hours as compared with no addition; the effect, however, was low as compared with that of the introduction of a benzoquinone functional group into the cinnamate group-containing polysiloxane by a chemical bond. The low improving effect on the VHR and the contrast ratio is considered to be attributable to the fact that the average distance between the cinnamate group and the radical-scavenging molecule of the additive was presumably relatively large, and that the polysiloxane and benzoquinone have different rates of dissolution into the liquid crystal layer.

### Examples 2-5 to 2-10 (Vertical Photo-Alignment UV2A)

Polysiloxane-based polymers containing a benzoquinone group represented by the following formula were synthesized as alignment film materials.

In the synthesized polysiloxanes, m was fixed at 0.3 and n was as follows.

(1) n=0 (Example 2-5)
(2) n=1 (Example 2-6)
(3) n=2 (Example 2-7)
(4) n=3 (Example 2-8)
(5) n=4 (Example 2-9)
(6) n=5 (Example 2-10)

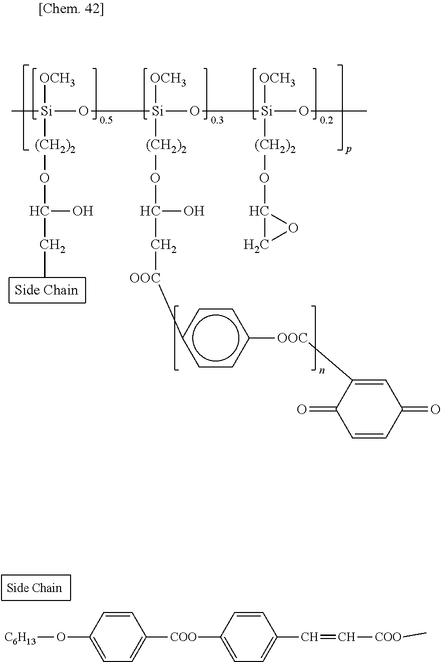

### (Production of Liquid Crystal Cell)

A pair of substrates, each including an ITO electrode, was provided. A mixed alignment agent of the corresponding cinnamate group-containing polysiloxane obtained in the above manner and a polyimide was applied to the substrates including an ITO electrode, followed by pre-baking at 90° C. for 5 minutes and then post-baking at 230° C. for 40 minutes. Thereby, double-layer alignment films were obtained, each of which contained the polymer having the chemical structure represented by the above formula in the surface layer. Then, the surfaces of the substrates each provided with an alignment film were irradiated with 20 mJ/cm² of linearly polarized ultraviolet light with a center wavelength of 330 nm, so that alignment treatment was performed. To one substrate was applied an ultraviolet-curable sealant (trade name: Photolec S-WB, Sekisui Chemical Co., Ltd.) in a predetermined pattern using a dispenser. Onto predetermined positions on the other substrate was dropped a negative liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an UV2A-mode liquid crystal cell was obtained.

### (High-Temperature Test on Backlight)

The voltage holding ratio (VHR) and the contrast ratio were measured before and after 5000-hour standing on a 75° C. backlight as in Example 2-1. The results are shown in Table 6.

TABLE 6

| | Before storage | | After 5000 h | |
|---|---|---|---|---|
| | VHR (%) | Contrast ratio | VHR (%) | Contrast ratio |
| n = 0 | 99.5 | 4500 | 91.3 | 3700 |
| n = 1 | 99.5 | 4500 | 94.1 | 3800 |
| n = 2 | 99.5 | 4500 | 95.0 | 3950 |
| n = 3 | 99.5 | 4500 | 96.6 | 4000 |
| n = 4 | 99.5 | 4400 | 96.5 | 4000 |
| n = 5 | 99.5 | 4400 | 96.6 | 4000 |

In the case of the alignment film material containing the polysiloxane represented by the above formula with n=0, both the VHR and the contrast ratio mildly decreased after the 5000-hour high-temperature test. Since the benzoquinone functional group was close to the main chain, the radical-scavenging effect was presumably lower.

In the case where n was within the range of 1 to 5, a VHR of 95% or higher was maintained when n was 2 or greater. The radical scavenging effect increased with an increase in n, and is assumed to have almost reached saturation when n was 2 or 3.

### Examples 2-11 to 2-14, Comparative Example 2-3 (Horizontal Photo-Alignment IPS)

Polyvinyl-based polymers containing a benzoquinone group represented by the following formula were synthesized as alignment film materials.

In the synthesized polyvinyl-based polymers, 1-m-r was fixed at 0.5 and m was as follows.

(1) m=0 (Comparative Example 2-3)
(2) m=0.1 (Example 2-11)
(3) m=0.2 (Example 2-12)
(4) m=0.3 (Example 2-13)
(5) m=0.4 (Example 2-14)

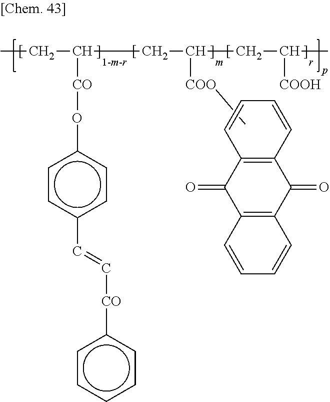

### (Production of Liquid Crystal Cell)

A substrate including a slit ITO electrode and a counter substrate including no electrode were provided. A mixed alignment agent of the corresponding chalcone group-containing polyvinyl-based polymer obtained in the above manner and a polyimide was applied to the substrates, followed by pre-baking at 90° C. for 5 minutes and then post-baking at 200° C. for 40 minutes. Thereby, double-layer alignment films were obtained, each of which contained the polymer having the chemical structure represented by the above formula in the surface layer. Then, the surfaces of the substrates each provided with an alignment film were irradiated with 2 J/cm² of linearly polarized ultraviolet light with a center wavelength of 365 nm, so that alignment treatment was performed. To one substrate (counter substrate including no electrode) was applied an ultraviolet-curable sealant (trade name: Photolec S-WB, Sekisui Chemical Co., Ltd.) in a predetermined pattern using a dispenser. Onto predetermined positions on the other substrate (substrate including a slit ITO electrode) was dropped a positive liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an IPS-mode liquid crystal cell was obtained.

### (High-Temperature Test on Backlight)

The voltage holding ratio (VHR) and the contrast ratio were measured before and after 5000-hour standing on a 75° C. backlight as in Example 2-1. The results are shown in Table 7.

TABLE 7

| | Before storage | | After 5000 h | |
|---|---|---|---|---|
| | VHR (%) | Contrast ratio | VHR (%) | Contrast ratio |
| m = 0 | 98.3 | 1200 | 91.3 | 880 |
| m = 0.1 | 98.1 | 1200 | 94.5 | 1000 |
| m = 0.2 | 98.4 | 1050 | 95.0 | 1000 |
| m = 0.3 | 98.2 | 1000 | 95.3 | 1000 |
| m = 0.4 | 97.3 | 850 | 94.7 | 670 |

In the case of the alignment film material containing the polyvinyl-based polymer represented by the above formula with m=0 (Comparative Example 2-3), both the VHR and the contrast ratio decreased after the 5000-hour high-temperature test. This is presumably because the chalcone group-containing polyvinyl-based polymer dissolved into the liquid crystal layer, and some chalcone groups were converted into radicals and ionized due to backlight illumination. In the case where m was within the range of 0.1 to 0.3, the decrease in VHR and the contrast ratio after the high-temperature test was small, and the contrast ratio remained at 1000 or higher. This is presumably because, both in the polyvinyl-based polymer remaining in the alignment film and in the polyvinyl-based polymer dissolved in the liquid crystal layer, radicals generated from the chalcone groups due to backlight illumination were effectively scavenged by the anthraquinone functional groups, so that ionization was less likely to occur. In the case where m was 0.4, the initial contrast ratio was low, and the contrast ratio after 5000 hours was even lower. This is presumably because, since the anthraquinone functional groups do not have alignment-imparting properties, the introduction of a large amount of bulky anthraquinone functional groups into the polyvinyl-based polymer decreased the liquid crystal alignment properties.

### Examples 2-15 to 2-18, Comparative Example 2-4 (Horizontal Alignment FFS)

Polyamic acids for photo-alignment containing an azobenzene group represented by the following formula were synthesized as alignment film materials.

In the polyamic acids for photo-alignment containing an azobenzene group, m was as follows.

(1) m=0 (Comparative Example 2-4)
(2) m=0.1 (Example 2-15)
(3) m=0.2 (Example 2-16)
(4) m=0.3 (Example 2-17)
(5) m=0.4 (Example 2-18)

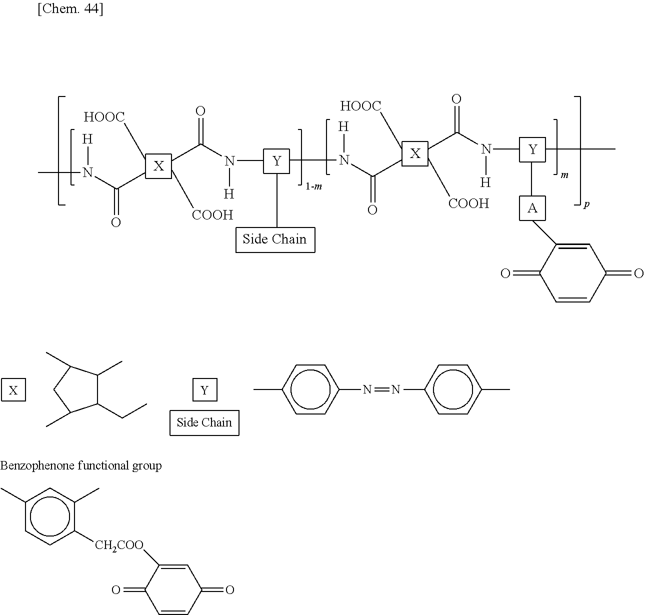

### (Production of Liquid Crystal Cell)

A substrate including an ITO electrode for an FFS-mode structure and a counter substrate including no electrode were provided. A mixed alignment agent of the corresponding azobenzene group-containing polyamic acid obtained in the above manner and a polyimide was applied to the substrates, followed by pre-baking at 90° C. for 5 minutes. Then, the surfaces of the substrates each provided with an alignment film were irradiated with 2 J/cm² of linearly polarized ultraviolet light with a center wavelength of 365 nm, so that alignment treatment was performed. This was followed by post-baking at 230° C. for 40 minutes. Thereby, double-layer alignment films were obtained, each of which contained the polymer having the chemical structure represented by the above formula in the surface layer. To one substrate (counter substrate including no electrode) was applied an ultraviolet-curable sealant (trade name: Photolec S-WB, Sekisui Chemical Co., Ltd.) in a predetermined pattern using a dispenser. Onto predetermined positions on the other substrate (substrate including an ITO electrode) was dropped a negative liquid crystal composition. The substrates were attached to each other in a vacuum and the sealant was cured by ultraviolet light. The workpiece was heated at 130° C. for 40 minutes and subjected to re-alignment treatment so that the liquid crystal was converted into an isotropic phase. Then, the workpiece was cooled down to room temperature, and thereby an FFS-mode liquid crystal cell was obtained.

### (High-Temperature Test on Backlight)

The voltage holding ratio (VHR) and the contrast ratio were measured before and after 5000-hour standing on a 75° C. backlight as in Example 2-1. The results are shown in Table 8.

TABLE 8

| | Before storage | | After 5000 h | |
|---|---|---|---|---|
| | VHR (%) | Contrast ratio | VHR (%) | Contrast ratio |
| m = 0 | 99.2 | 1100 | 83.3 | 800 |
| m = 0.1 | 99.2 | 1100 | 87.8 | 930 |
| m = 0.2 | 99.2 | 1000 | 89.5 | 940 |
| m = 0.3 | 99.3 | 1000 | 90.5 | 950 |
| m = 0.4 | 99.3 | 820 | 87.0 | 700 |

In the case of the alignment film material containing the polyamic acid represented by the above formula with m=0 (Comparative Example 2-4), both the VHR and the contrast ratio greatly decreased after the test on the 75° C. backlight. This is presumably because the azobenzene group-containing polyamic acid dissolved into the liquid crystal layer, and some azobenzene groups were converted into radicals and ionized due to backlight illumination. In the case where m was within the range of 0.1 to 0.3, the decrease in VHR and the contrast ratio after the high-temperature test was relatively small. This is presumably because, both in the polyamic acid remaining in the alignment film and in the polyamic acid dissolved in the liquid crystal layer, radicals generated from the azobenzene groups due to backlight illumination were effectively scavenged by the benzoquinone functional groups, so that ionization was less likely to occur. In the case where m was 0.4, the initial contrast ratio was low, and the contrast ratio after 5000 hours was even lower. This is presumably because the introduction of a large amount of benzoquinone functional groups into the polyamic acid decreased the amount of azobenzene-containing side chains, thus decreasing the liquid crystal alignment properties.

The aforementioned liquid crystal display devices of the respective examples may also be applied to production of liquid crystal display devices of a different mode, such as an ECB mode, a TN mode, or a vertical alignment TN (VATN) mode.

### [Additional Remarks]

Examples of preferred aspects of the alignment film, polymer and liquid crystal display device of the present invention will be listed below. The preferred examples described below, as well as the preferred examples described above, are examples of preferred aspects of the present invention. These examples may be appropriately combined without departing from the gist of the present invention.

One aspect of the present invention may be an alignment film including: a polymer containing a piperidine skeleton-containing group and/or a quinone group, the polymer further containing a photo-aligning functional group.

In the alignment film of the present invention, the piperidine skeleton-containing group preferably contains a group represented by the following formula (a1):

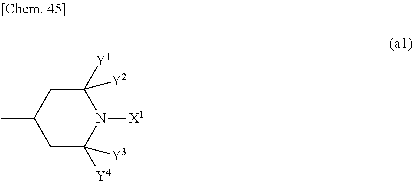

wherein X¹ is a hydrogen atom, an alkoxy group (OR) which may contain a substituent, an oxygen radical group (O.), or a hydroxy group; Y¹, Y², Y³, and Y⁴ are the same as or different from each other and each a monovalent organic group or a divalent organic group; Y¹ and Y² may be bonded to each other; Y³ and Y⁴ may be bonded to each other.

X¹ is preferably a hydrogen atom, an alkoxy group which may contain a substituent, or an oxygen radical group, more preferably a hydrogen atom, an isopropoxy group, a cyclohexyloxy group, an acetophenoxy group, a benzoxy group, or an oxygen radical group, still more preferably a hydrogen atom or an oxygen radical group.

Rs in the alkoxy groups which may contain a substituent are the same as or different from each other and each a C1-C20 linear or branched alkyl chain (where one —CH₂— group or two or more —CH₂— groups may be replaced with —O— or —(C═O)—, but preferably both of two adjacent —CH₂— groups are not replaced with —O—), a hydrocarbon group containing a cycloalkyl group or an alkylcycloalkyl unit (where one —CH₂— group or two or more —CH₂— groups may be replaced with —O— or —(C═O)—, but preferably both of two adjacent —CH₂— groups are not replaced with —O—; and one H atom or two or more H atoms may be replaced with OR′, N(R¹)(R²), or R³), or an aromatic or heteroaromatic hydrocarbon group (where one H atom or two or more H atoms may be replaced with OR′, N(R¹)(R²), or R³). One —CH₂— group or two or more —CH₂— groups may be replaced with 1,4-cyclohexylene (where one or two or more —CH₂— groups may be replaced with —O—, —CO— or —NR¹—). Rs are each preferably, for example, an acetophenyl group, an isopropyl group, or 3-heptyl group.

When multiple R¹s are present, R¹s are the same as or different from each other and each a C1-C10 linear or branched alkyl group, a C1-C10 acyl group, a C6-C12 aromatic hydrocarbon or a carboxy group. When multiple R²s are present, R²s are the same as or different from each other and each a C1-C10 linear or branched alkyl group, a C1-C10 acyl group, a C6-C12 aromatic hydrocarbon group, or a carboxy group. When multiple R³s are present, R³s are the same as or different from each other and each a C1-C10 linear or branched alkyl group, where one —CH₂— group or two or more —CH₂— groups may be replaced with —O— or —(C═O)—, but preferably both of two adjacent —CH₂— groups are not replaced with —O—.

Y¹ to Y⁴ may be the same as or different from each other and each a C1-C4 alkyl group. Alternatively, Y¹ and Y² may be bonded to each other to form a C3-C6 divalent group and Y³ and Y⁴ may be bonded to each other to form a C3-C6 divalent group.

In the alignment film of the present invention, the piperidine skeleton-containing group is more preferably a group represented by the following formula (a2):

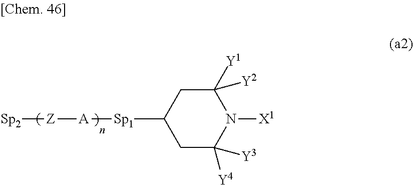

wherein Sp₁ is a direct bond or a divalent linking group; A's are the same as or different from each other and each a divalent organic group; Zs are the same as or different from each other and each a direct bond or a divalent linking group; Sp₂ is a divalent linking group; n is an integer of 1 to 10; X¹, Y¹, Y², Y³, and Y⁴ are the same as those in the formula (a1).

The divalent linking group for Sp₁ may be, for example, an —O— group, —S— group, —NH— group, —CO— group, —COO— group, —OCO— group, —O—COO— group, —OCH₂— group, —OH₂O— group, —SCH₂— group, —CH₂S— group, —N(OH₃)— group, —N(C₂H₅)— group, —N(C₃H₇)— group, —N(O₄H₉)— group, —OF₂O— group, —OCF₂— group, —CF₂S— group, —SCF₂— group, —N(CF₃)— group, —CH₂CH₂— group, —CF₂OH₂— group, —CH₂CF₂— group, —CF₂CF₂— group, —CH═CH— group, —CF═CF— group, —C≡C— group, —CH═CH—COO— group, or —OCO—CH═CH— group.

The divalent organic group for A may be, for example, a 1,2-phenylene group, 1,3-phenylene group, 1,4-phenylene group, naphthalene-1,4-diyl group, naphthalene-1,5-diyl group, naphthalene-2,6-diyl group, 1,4-cyclohexylene group, 1,4-cyclohexenylene group, 1,4-bicyclo[2,2,2]octylene group, piperidine-1,4-diyl group, decahydronaphthalene-2,6-diyl group, 1,2,3,4-tetrahydronaphthalene-2,6-diyl group, indane-1,3-diyl group, indane-1,5-diyl group, indane-2,5-diyl group, phenanthrene-1,6-diyl group, phenanthrene-1,8-diyl group, phenanthrene-2,7-diyl group, or phenanthrene-3,6-diyl group.

The divalent linking group for Z may be, for example, an —O— group, —S— group, —NH— group, —CO— group, —COO— group, —OCO— group, —O—COO— group, —OCH₂— group, —CH₂O— group, —SCH₂— group, —CH_{A}S— group, —N(CH₃)— group, —N(C₂H₅)— group, —N(C₃H₇)— group, —N(C₄H₉)— group, —CF₂O— group, —OCF₂— group, —CF₂S— group, —SCF₂— group, —N(CF₃)— group, —CH₂CH₂— group, —CF₂CH₂— group, —CH₂CF₂— group, —CF₂CF₂— group, —CH═CH— group, —CF═CF— group, —C═C— group, —CH═CH—COO— group, or —OCO—CH═CH— group.

The divalent linking group for Sp₂ may be, for example, a —COO— group, —O— group, and —NH— group.

In the alignment film of the present invention, the quinone group preferably contains a group represented by the following formula (b1) or (c1):

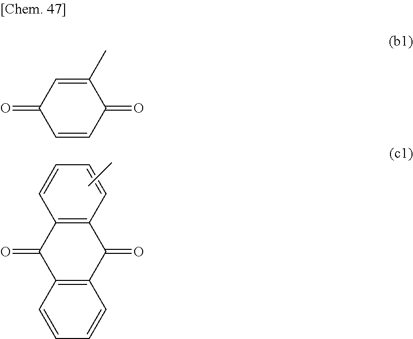

A hydrogen atom contained in the group represented by the formula (b1) or (c1) may be replaced with an alkyl group, an alkoxy group, or a halogen atom. The hydrogen atom may be replaced with, for example, a methyl group, an ethyl group, a n-propyl group, an isopropyl group, a n-butyl group, an isobutyl group, a methoxy group, an ethoxy group, a n-propoxy group, an isopropoxy group, a n-butoxy group, an isobutoxy group, or a halogen atom.

In the alignment film of the present invention, the polymer preferably contains a group represented by the following formula (b2) or (c2):

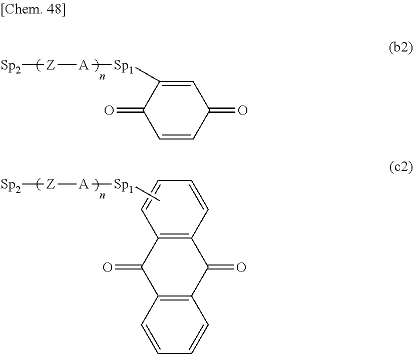

wherein Sp₁ is a direct bond or a divalent linking group; A's are the same as or different from each other and each a divalent organic group; Zs are the same as or different from each other and each a direct bond or a divalent linking group; Sp₂ is a divalent linking group; and n is an integer of 1 to 10.

Specific examples of the divalent linking group for Sp₁, the divalent organic group for A, the divalent linking group for Z, and the divalent linking group for Sp₂ are the same as those described above for the formula (a2).

In the alignment film of the present invention, the polymer is preferably a polyamic acid, a polyimide, a polysiloxane, a polyacryl, a polymethacryl, or a polyvinyl. The polymer is more preferably, for example, a polysiloxane or a polyvinyl. The expression “the polymer is a polyamic acid” means that the main chain of the polymer is derived from a polyamic acid. The same shall apply to other polymers.

In the alignment film of the present invention, the photo-aligning functional group is preferably at least one selected from the group consisting of a cinnamate group, an azobenzene group, a chalcone group, a coumarin group, a stilbene group, and a tolane group.

In the alignment film of the present invention, the polymer preferably contains a vertically aligning group. In the alignment film of the present invention, the polymer preferably contains a horizontally aligning group.

In the alignment film of the present invention, the polymer is preferably a polysiloxane including a structure represented by the following formula (iv) or the following formula (v).

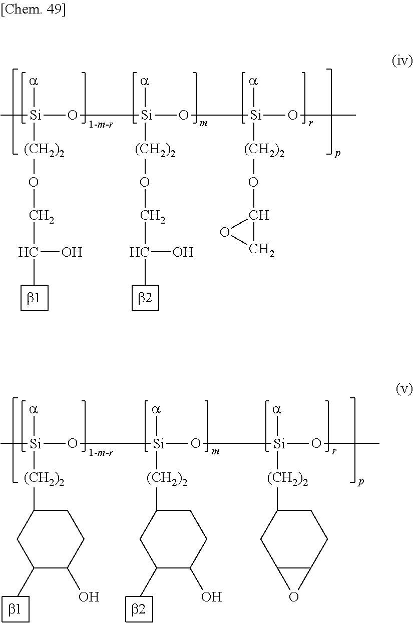

wherein as are the same as or different from each other and each a hydrogen atom, a methyl group, an ethyl group, a hydroxy group, a methoxy group, or an ethoxy group; m represents the amount of a monomer unit containing a piperidine skeleton-containing group or a quinone group to be introduced, and is greater than 0; r represents the amount of a monomer unit containing a carboxy group to be introduced, and is 0 or greater; the sum of m and r is less than 1; p represents the degree of polymerization, and is an integer of 1 or greater; β¹s are the same as or different from each other and each a photo-reactive functional group, or a vertically or horizontally aligning group other than the photo-reactive functional group; β²s are the same as or different from each other and each a piperidine skeleton-containing group or a quinone group.

In the alignment film of the present invention, the polymer is preferably a polyvinyl including a structure represented by the following formula (vi):

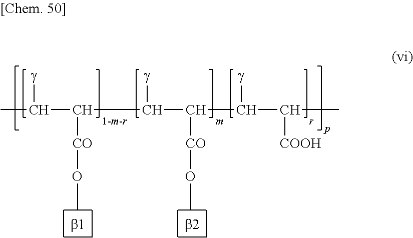

wherein γs are the same as or different from each other and each a hydrogen atom, a methyl group, an ethyl group, a hydroxy group, a methoxy group, or an ethoxy group; m represents the amount of a monomer unit containing a piperidine skeleton-containing group or a quinone group to be introduced, and is greater than 0; r represents the amount of a monomer unit containing a carboxy group to be introduced, and is 0 or greater; the sum of m and r is less than 1; p represents the degree of polymerization, and is an integer of 1 or greater; β¹s are the same as or different from each other and each a photo-reactive functional group, or a vertically or horizontally aligning group other than the photo-reactive functional group; β²s are the same as or different from each other and each a piperidine skeleton-containing group or a quinone group.

The alignment film of the present invention may further contain a polyamic acid and/or a polyimide that contain(s) no photo-aligning functional group. The alignment film of the present invention may further contain a polyamic acid and/or a polyimide that contain(s) neither piperidine skeleton-containing group nor quinone group.

Another aspect of the present invention is a polymer for use in the alignment film of the present invention, the polymer containing: a piperidine skeleton-containing group and/or a quinone group.

Still another aspect of the present invention may be the use of a polymer containing at least one selected from the group consisting of a piperidine skeleton-containing group and a quinone group, as a polymer constituting an alignment film.

Still another aspect of the present invention is a liquid crystal display device including: the alignment film of the present invention; a pair of substrates; and a liquid crystal layer disposed between the substrates, wherein the alignment film is disposed between at least one of the substrates and the liquid crystal layer.

The liquid crystal layer preferably contains a negative liquid crystal material. The liquid crystal display panel of the present invention can sufficiently reduce image sticking and stains even with the liquid crystal layer containing a negative liquid crystal material.

The display mode of the liquid crystal display device of the present invention is preferably the twisted nematic (TN) mode, the electrically controlled birefringence (ECB) mode, the IPS mode, the FFS mode, the VA mode, or the VATN mode. The liquid crystal display device of the present invention may be a transmissive, reflective, or transflective liquid crystal display device. When the liquid crystal display device of the present invention is a transmissive or transflective liquid crystal display device, the liquid crystal display device of the present invention typically includes a backlight.

### REFERENCE SIGNS LIST

11: Lower glass substrate
13, 23, 113: Alignment film
131: Photo-aligning functional group
13p: Polymer portion
13r: Radical-scavenging group
21: Upper glass substrate
31, 131: Liquid crystal layer
33: Seal
41: Backlight

1. An alignment film comprising:
a polymer containing a piperidine skeleton-containing group and/or a quinone group; and
a photo-aligning functional group.

2. The alignment film according to claim 1,
wherein the piperidine skeleton-containing group contains a group represented by the following formula (a1): 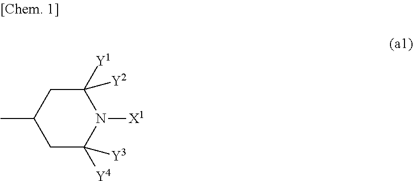
wherein X¹ is a hydrogen atom, an alkoxy group which may contain a substituent, an oxygen radical group, or a hydroxy group; Y¹, Y², Y³, and Y⁴ are the same as or different from each other and each a monovalent organic group or a divalent organic group; Y¹ and Y² may be bonded to each other; and Y³ and Y⁴ may be bonded to each other.

3. The alignment film according to claim 2,
wherein X¹ is a hydrogen atom or an oxygen radical group.

4. The alignment film according to claim 2,
wherein the piperidine skeleton-containing group is a group represented by the following formula (a2): 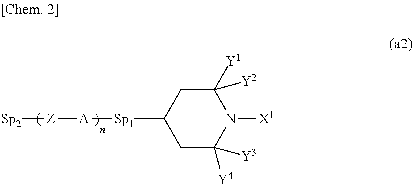
wherein Sp₁ is a direct bond or a divalent linking group; A's are the same as or different from each other and each a divalent organic group; Zs are the same as or different from each other and each a direct bond or a divalent linking group; Sp₂ is a divalent linking group; n is an integer of 1 to 10; X¹, Y¹, Y², Y³, and Y⁴ are the same as those in the formula (a1).

5. The alignment film according to claim 1,
wherein the quinone group contains a group represented by the following formula (b1) or (c1): 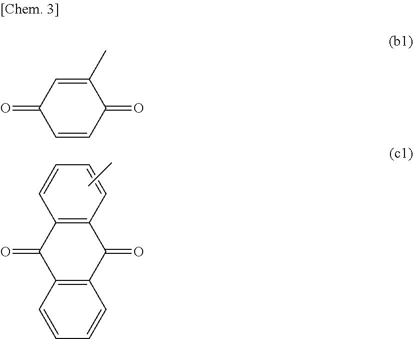
wherein a hydrogen atom of the group represented by the formula (b1) or (c1) may be replaced with an alkyl group, an alkoxy group, or a halogen atom.

6. The alignment film according to claim 5,
wherein the polymer contains a group represented by the following formula (b2) or (c2): 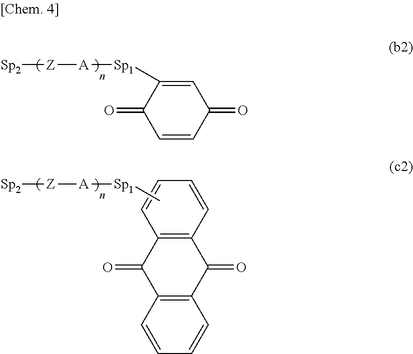
wherein Sp₁ is a direct bond or a divalent linking group; A's are the same as or different from each other and each a divalent organic group; Zs are the same as or different from each other and each a direct bond or a divalent linking group; Sp₂ is a divalent linking group; and n is an integer of 1 to 10.

7. The alignment film according to claim 1,
wherein the polymer is a polyamic acid, a polyimide, a polysiloxane, a polyacryl, a polymethacryl, or a polyvinyl.

8. The alignment film according to claim 1,
wherein the photo-aligning functional group is at least one selected from the group consisting of a cinnamate group, an azobenzene group, a chalcone group, a coumarin group, a stilbene group, and a tolane group.

9. A polymer for use in the alignment film according to claim 1, the polymer comprising:
a piperidine skeleton-containing group and/or a quinone group.

10. A liquid crystal display device comprising:
the alignment film according to claim 1;
a pair of substrates; and
a liquid crystal layer disposed between the substrates,
wherein the alignment film is disposed between at least one of the substrates and the liquid crystal layer.

11. The liquid crystal display device according to claim 10,
the liquid crystal layer contains a negative liquid crystal material.
